(19) United States
(12) Patent Application Publication
(10) Pub. No.: US 2019/0306825 A1
(43) Pub. Date: Oct. 3, 2019

(54) ACCESS POINT (AP) TO ACCESS POINT (AP) RANGING FOR PASSIVE LOCATIONING

(71) Applicant: QUALCOMM Incorporated, San Diego, CA (US)

(72) Inventors: Erik David Lindskog, Cupertino, CA (US); Alireza Raissinia, Monte Sereno, CA (US)

(21) Appl. No.: 16/277,353

(22) Filed: Feb. 15, 2019

Related U.S. Application Data
(60) Provisional application No. 62/651,405, filed on Apr. 2, 2018.

(51) Int. Cl. H04W 64/00; H04W 24/08

(52) U.S. Cl. CPC H04W 64/00; H04W 88/08; H04W 24/08

(57) ABSTRACT

This disclosure provides systems, methods and apparatuses, including computer programs encoded on computer storage media, for performing a ranging operation with a responder device. In one aspect, an apparatus exchanges a number of measurement frames with the responder device. The apparatus captures a number of timestamps based on the exchanged measurement frames. The apparatus estimates a carrier frequency offset between the responder device and the apparatus, and reports information indicative of the captured timestamps to the responder device.

### CROSS-REFERENCE TO RELATED APPLICATIONS

This patent application claims priority under 35 U.S.C. 119 to U.S. Provisional Patent Application No. 62/651,405 entitled “ACCESS POINT (AP) TO ACCESS POINT (AP) RANGING FOR PASSIVE LOCATIONING” filed on Apr. 2, 2018. The disclosures of all prior applications are considered part of and are incorporated by reference in this patent application.

### TECHNICAL FIELD

This disclosure relates generally to wireless networks, and specifically to ranging operations for passive locationing.

### DESCRIPTION OF THE RELATED TECHNOLOGY

The recent proliferation of WiFi® access points in wireless local area networks (WLANs) has made it possible for positioning systems to use these access points for position determination, especially in areas where there is a large concentration of active Wi-Fi access points (such as urban cores, shopping centers, office buildings, sporting venues, and so on). For example, a wireless device such as a cell phone or tablet computer may use the round trip time (RTT) of signals exchanged with an access point (AP) to determine the distance between the wireless device and the AP. Similarly, the AP may use the RTT of signals exchanged with the wireless device to determine the distance between itself and the wireless device. Once the distances between the wireless device and three APs having known locations are determined, the location of the wireless device may be determined using trilateration techniques.

Because ranging operations are becoming more important for position determination, it is desirable to increase the speed and accuracy with which ranging operations are performed. It is also desirable to perform ranging operations with multiple wireless devices at the same time, and to allow wireless devices to passively participate in ranging operations.

### SUMMARY

The systems, methods and devices of this disclosure each have several innovative aspects, no single one of which is solely responsible for the desirable attributes disclosed herein.

One innovative aspect of the subject matter described in this disclosure can be implemented as a method for performing a ranging operation between an initiator device and a responder device. In some implementations, the method may be performed by the initiator device and may include exchanging a number of measurement frames with the responder device, capturing a number of timestamps based on the exchanged measurement frames, estimating a carrier frequency offset between the responder device and the initiator device, and reporting information indicative of the captured timestamps to the responder device. In some implementations, the exchanged measurement frames may include at least one of down-link multi-user null data packets (DL MU-NDPs) transmitted from the responder device, an up-link multi-user null data packet (UL MU-NDP) transmitted from the initiator device, and an up-link single-user null data packet (SU UL NDP). The reported information may include at least one of the captured timestamps, a difference between the captured timestamps, or an indication of the estimated carrier frequency offset. In addition, or in the alternative, the method may include correcting the captured timestamps based at least in part on the estimated carrier frequency offset, and reporting information indicative of the corrected timestamps to the responder device.

In some implementations, the captured timestamps may be corrected by selecting one of the timestamps as a reference timestamp and adjusting the timestamps based on the reference timestamp and the estimated carrier frequency offset. In some implementations, the reference timestamp may be a time of departure (TOD) of an uplink multi-user null data packet (UL MU-NDP) or an uplink null data packet (UL NDP) transmitted from the initiator device. In some aspects, the reference timestamp may be set to a zero value or may be an arbitrary value based on a counter. In addition, or in the alternative, the method may include adjusting a transmit carrier frequency of the initiator device based at least in part on the estimated carrier frequency offset, and transmitting the estimated carrier frequency offset to the responder device.

Another innovative aspect of the subject matter described in this disclosure can be implemented in an apparatus for performing a ranging operation with a responder device. The apparatus may include one or more transceivers, one or more processors, and a memory. The one or more transceivers may be configured to exchange wireless signals with one or more wireless devices. In some implementations, the memory may include instructions that, when executed by the one or more processors, cause the apparatus to exchange a number of measurement frames with the responder device, capture a number of timestamps based on the exchanged measurement frames, estimate a carrier frequency offset between the responder device and the apparatus, and report information indicative of the captured timestamps to the responder device. In some implementations, the exchanged measurement frames may include at least one of down-link multi-user null data packets (DL MU-NDPs) transmitted from the responder device, an up-link multi-user null data packet (UL MU-NDP) transmitted from the apparatus, and an up-link single-user null data packet (SU UL NDP). The reported information may include at least one of the captured timestamps, a difference between the captured timestamps, or an indication of the estimated carrier frequency offset. In addition, or in the alternative, execution of the instructions may further cause the apparatus to correct the captured timestamps based at least in part on the estimated carrier frequency offset, and to report information indicative of the corrected timestamps to the responder device.

In some implementations, the captured timestamps may be corrected by selecting one of the timestamps as a reference timestamp and adjusting the timestamps based on the reference timestamp and the estimated carrier frequency offset. In some implementations, the reference timestamp may be a time of departure (TOD) of an uplink multi-user null data packet (UL MU-NDP) or an uplink null data packet (UL NDP) transmitted from the apparatus. In some aspects, the reference timestamp may be set to a zero value or may be an arbitrary value based on a counter. In addition, or in the alternative, execution of the instructions may cause the apparatus to adjust a transmit carrier frequency of the apparatus based, at least in part, on the estimated carrier frequency offset, and to transmit the estimated carrier frequency offset to the responder device.

Another innovative aspect of the subject matter described in this disclosure can be implemented in a non-transitory computer-readable medium. The non-transitory computer-readable medium may store instructions that, when executed by one or more processors of an apparatus, cause the apparatus to perform a ranging operation with a responder device by performing a number of operations. In some implementations, the number of operations may include exchanging a number of measurement frames with the responder device, capturing a number of timestamps based on the exchanged measurement frames, estimating a carrier frequency offset between the responder device and the apparatus, and reporting information indicative of the captured timestamps to the responder device. In some implementations, the exchanged measurement frames may include at least one of down-link multi-user null data packets (DL MU-NDPs) transmitted from the responder device, an up-link multi-user null data packet (UL MU-NDP) transmitted from the apparatus, and an up-link single-user null data packet (SU UL NDP). The reported information may include at least one of the captured timestamps, a difference between the captured timestamps, or an indication of the estimated carrier frequency offset. In addition, or in the alternative, execution of the instructions may further cause the apparatus to perform operations further comprising correcting the captured timestamps based at least in part on the estimated carrier frequency offset, and reporting information indicative of the corrected timestamps to the responder device.

In some implementations, the captured timestamps may be corrected by selecting one of the timestamps as a reference timestamp and adjusting the timestamps based on the reference timestamp and the estimated carrier frequency offset. In some implementations, the reference timestamp may be a time of departure (TOD) of an uplink multi-user null data packet (UL MU-NDP) or an uplink null data packet (UL NDP) transmitted from the apparatus. In some aspects, the reference timestamp may be set to a zero value or may be an arbitrary value based on a counter. In addition, or in the alternative, the number of operations may include adjusting a transmit carrier frequency of the apparatus based at least in part on the estimated carrier frequency offset, and transmitting the estimated carrier frequency offset to the responder device.

Another innovative aspect of the subject matter described in this disclosure can be implemented in an apparatus. In some implementations, the apparatus may include means for exchanging a number of measurement frames with a responder device, means for capturing a number of timestamps based on the exchanged measurement frames, means for estimating a carrier frequency offset between the responder device and the apparatus, and means for reporting information indicative of the captured timestamps to the responder device. In some implementations, the exchanged measurement frames may include at least one of down-link multi-user null data packets (DL MU-NDPs) transmitted from the responder device, an up-link multi-user null data packet (UL MU-NDP) transmitted from the apparatus, and an up-link single-user null data packet (SU UL NDP). The reported information may include at least one of the captured timestamps, a difference between the captured timestamps, or an indication of the estimated carrier frequency offset. In addition, or in the alternative, the apparatus may include means for correcting the captured timestamps based at least in part on the estimated carrier frequency offset, and means for reporting information indicative of the corrected timestamps to the responder device.

In some implementations, the captured timestamps may be corrected by selecting one of the timestamps as a reference timestamp and adjusting the timestamps based on the reference timestamp and the estimated carrier frequency offset. In some implementations, the reference timestamp may be a time of departure (TOD) of an uplink multi-user null data packet (UL MU-NDP) or an uplink null data packet (UL NDP) transmitted from the apparatus. In some aspects, the reference timestamp may be set to a zero value or may be an arbitrary value based on a counter. In addition, or in the alternative, the apparatus may include means for adjusting a transmit carrier frequency of the initiator device based at least in part on the estimated carrier frequency offset, and means for transmitting the estimated carrier frequency offset to the responder device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram of an example wireless system.

FIG. 2 shows a block diagram of an example access point.

FIG. 3 shows a block diagram of an example wireless station.

FIG. 4 shows a signal diagram of an example ranging operation.

FIG. 5A shows a timing diagram of an example ranging operation.

FIG. 5B shows a sequence diagram of the example ranging operation of FIG. 5A.

FIG. 6A shows a timing diagram of another example ranging operation.

FIG. 6B shows a sequence diagram of the example ranging operation of FIG. 6A.

FIG. 7A shows a timing diagram of another example ranging operation.

FIG. 7B shows a sequence diagram of the example ranging operation of FIG. 7A.

FIG. 8 shows a signal diagram of an example passive positioning operation.

FIG. 9A shows an illustrative flow chart depicting an example ranging operation.

FIG. 9B shows an illustrative flow chart depicting another example ranging operation.

FIG. 9C shows an illustrative flow chart depicting another example ranging operation.

FIG. 10 shows an illustrative flow chart depicting an example operation for adjusting timestamps.

FIG. 11 shows an example trigger frame.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular, or internet of things (IOT) network, such as a system utilizing 3G, 4G, or 5G, or further implementations thereof, technology.

Implementations of the subject matter described in this disclosure may be used for adjusting timestamps measured during a ranging operation to compensate for clock offsets between wireless devices participating in the ranging operation. In some implementations, the ranging operation may be performed between an access point (AP) operating as a responder device and a number of groups of wireless stations operating as initiator devices. Clock offsets between the responder device and the initiator devices may cause timing errors in one or more measured timestamps used to calculate RTT values for the ranging operation. In some implementations, each of the initiator devices may estimate a carrier frequency offset between itself and the responder device, and may report information indicative of the captured timestamps to the responder device. The timestamps captured by a respective initiator device may be adjusted based on the estimated carrier frequency offset between the respective initiator device and the responder device to generate corrected timestamps. The corrected timestamps may compensate for clock offsets between the responder device and the initiator device, for example, to eliminate timing errors in timestamps captured by the initiator devices. In some implementations, the initiator devices may report the corrected timestamps (rather than the captured timestamps) to the responder device in uplink frames, and the corrected timestamps may be used to determine accurate RTT values between the responder device and the initiator devices. In some implementations, a respective initiator device may select one of the timestamps as a reference timestamp and may adjust the other timestamps relative to the reference timestamp to generate the corrected timestamps.

Particular implementations of the subject matter described in this disclosure can be implemented to realize one or more of the following potential advantages. The initiator devices may compensate for clock offsets relative to the responder device by estimating carrier frequency offsets relative to the responder device that can be used to correct timestamps captured by the initiator devices, thereby increasing the accuracy with which RTT values may be determined. In some implementations, a respective initiator device may report one or more of the captured timestamps, differences between the captured timestamps, and the estimated carrier frequency offset to the responder device in uplink frames. In some other implementations, the respective initiator device may report the corrected timestamps (such as rather than the captured timestamps or estimated carrier frequency offset values) to the responder device in uplink frames. When reporting the corrected timestamps to the responder device in uplink frames, the initiator devices may not need to report their estimated carrier frequency offset values to the responder device in the uplink frames, thereby reducing the size and transmit duration of the uplink frames.

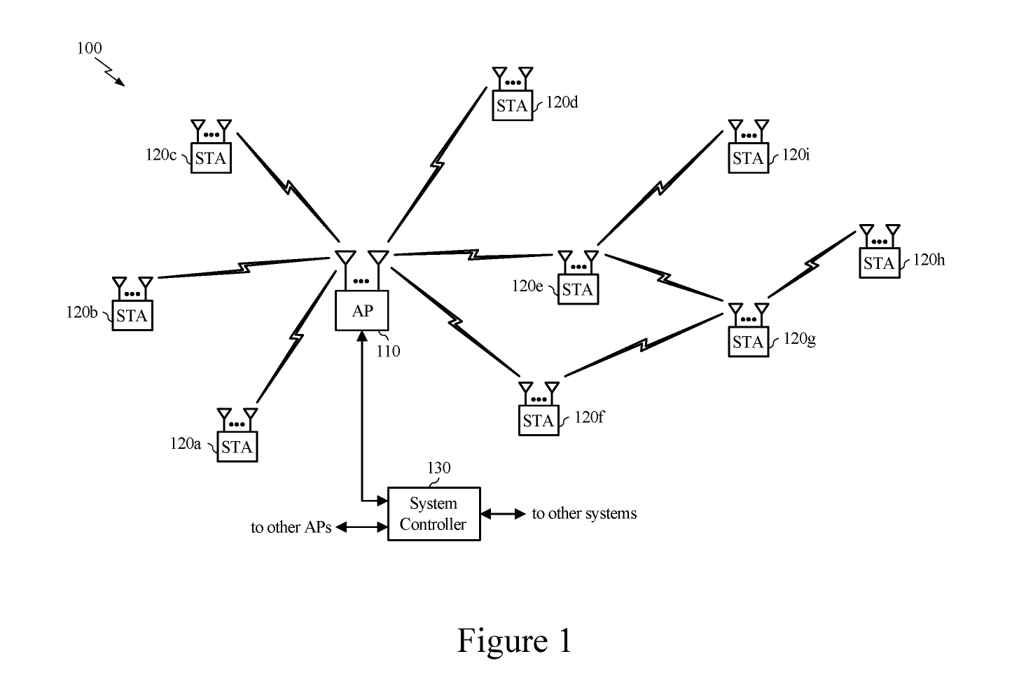

FIG. 1 shows a block diagram of an example wireless system 100. The wireless system 100 is shown to include a wireless access point (AP) 110 and a number of wireless stations (STAs) 120a-120i. For simplicity, one AP 110 is shown in FIG. 1. The AP 110 may form a wireless local area network (WLAN) that allows the AP 110, the STAs 120a-120i, and other wireless devices (not shown for simplicity) to communicate with each other over a wireless medium. The wireless medium, which may be divided into a number of channels or into a number of resource units (RUs), may facilitate wireless communications between the AP 110, the STAs 120a-120i, and other wireless devices connected to the WLAN. In some implementations, the STAs 120a-120i can communicate with each other using peer-to-peer communications (such as without the presence or involvement of the AP 110). The AP 110 may be assigned a unique MAC address that is programmed therein by, for example, the manufacturer of the access point. Similarly, each of the STAs 120a-120i also may be assigned a unique MAC address.

In some implementations, the wireless system 100 may correspond to a multiple-input multiple-output (MIMO) wireless network and may support single-user MIMO (SU-MIMO) and multi-user (MU-MIMO) communications. In some implementations, the wireless system 100 may support orthogonal frequency-division multiple access (OFDMA) communications. Further, although the WLAN is depicted in FIG. 1 as an infrastructure Basic Service Set (BSS), in some other implementations, the WLAN may be an Independent Basic Service Set (IB SS), an Extended Service Set (ESS), an ad-hoc network, or a peer-to-peer (P2P) network (such as operating according to one or more Wi-Fi Direct protocols).

The STAs 120a-120i may be any suitable Wi-Fi enabled wireless devices including, for example, cell phones, personal digital assistants (PDAs), tablet devices, laptop computers, or the like. The STAs 120a-120i also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The AP 110 may be any suitable device that allows one or more wireless devices (such as the STAs 120a-120i) to connect to another network (such as a local area network (LAN), wide area network (WAN), metropolitan area network (MAN), or the Internet). In some implementations, a system controller 130 may facilitate communications between the AP 110 and other networks or systems. In some implementations, the system controller 130 may facilitate communications between the AP 110 and one or more other APs (not shown for simplicity) that may be associated with other wireless networks. In addition, or in the alternative, the AP 110 may exchange signals and information with one or more other APs using wireless communications.

The AP 110 may periodically broadcast beacon frames to enable the STAs 120a-120i and other wireless devices within wireless range of the AP 110 to establish and maintain a communication link with the AP 110. The bacon frames, which may indicate downlink (DL) data transmissions to the STAs 120a-120i and solicit or schedule uplink (UL) data transmissions from the STAs 120a-120i, are typically broadcast according to a target beacon transmission time (TBTT) schedule. The broadcasted beacon frames may include a timing synchronization function (TSF) value of the AP 110. The STAs 120a-120i may synchronize their own local TSF values with the broadcasted TSF value, for example, so that all of the STAs 120a-120i are synchronized with each other and with the AP 110.

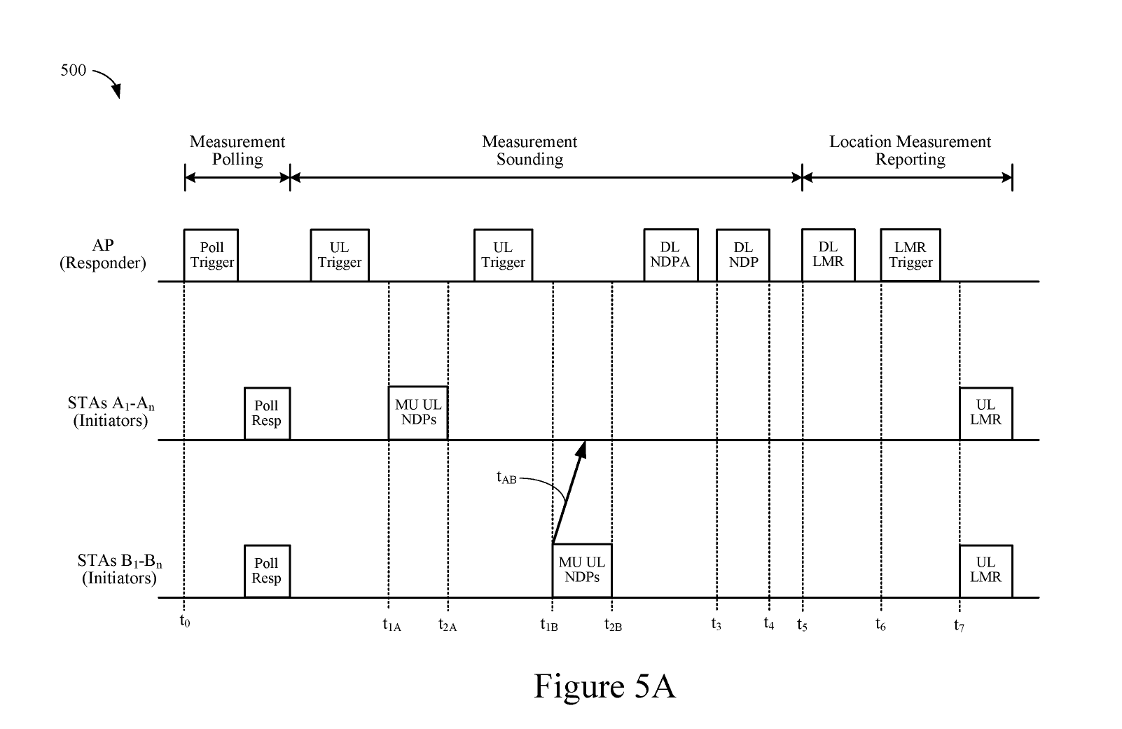

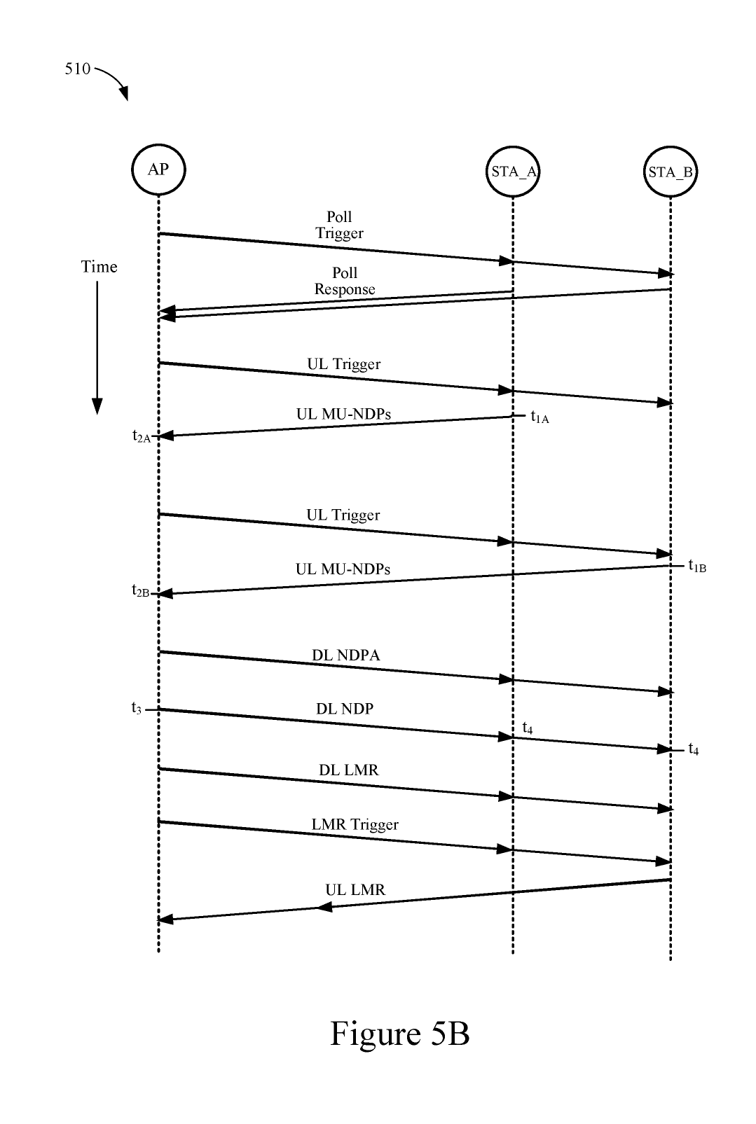

In some implementations, each of the stations STAs 120a-120i and the AP 110 may include one or more transceivers, one or more processing resources (such as processors or Application-Specific Integrated Circuits (ASICs)), one or more memory resources, and a power source (such as a battery). The one or more transceivers may include Wi-Fi transceivers, Bluetooth transceivers, cellular transceivers, or other suitable radio frequency (RF) transceivers (not shown for simplicity) to transmit and receive wireless communication signals. In some implementations, each transceiver may communicate with other wireless devices in distinct frequency bands or using distinct communication protocols. The memory resources may include a non-transitory computer-readable medium (such as one or more nonvolatile memory elements, such as EPROM, EEPROM, Flash memory, a hard drive, etc.) that stores instructions for performing one or more operations described with respect to FIGS. 5A-5B, 6A-6B, 7A-7B, 8, 9A-9C, and 10.

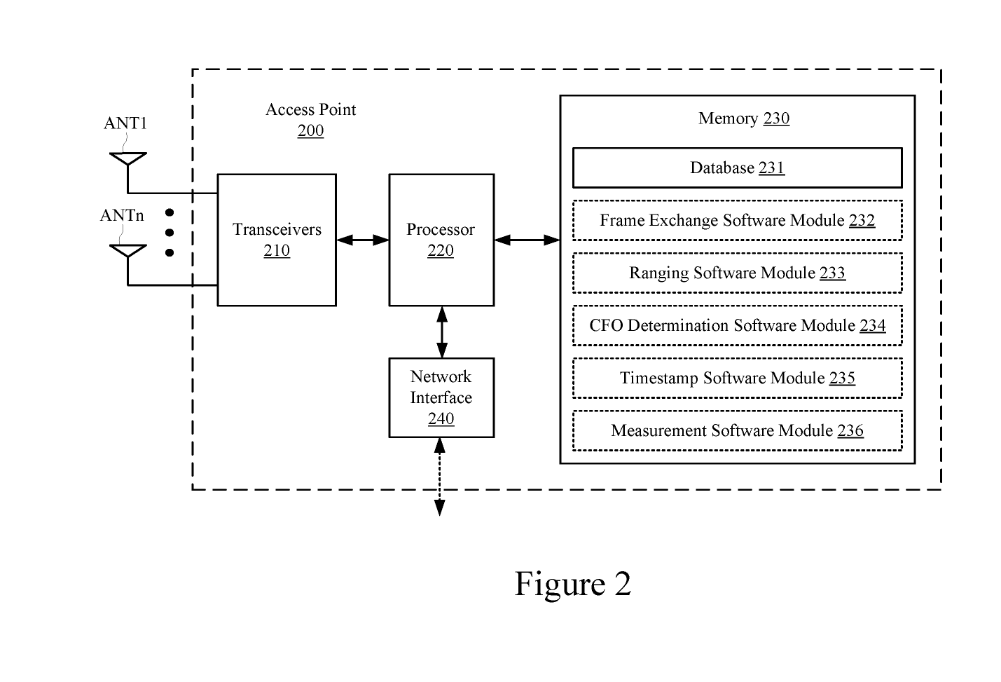

FIG. 2 shows an example access point (AP) 200. The AP 200 may be one implementation of the AP 110 of FIG. 1. The AP 200 may include one or more transceivers 210, a processor 220, a memory 230, a network interface 240, and a number of antennas ANT1-ANTn. The transceivers 210 may be coupled to the antennas ANT1-ANTn, either directly or through an antenna selection circuit (not shown for simplicity). The transceivers 210 may be used to transmit signals to and receive signals from other wireless devices including, for example, one or more of the STAs 120a-120i of FIG. 1 and other APs. Although not shown in FIG. 2 for simplicity, the transceivers 210 may include any number of transmit chains to process and transmit signals to other wireless devices via the antennas ANT1-ANTn, and may include any number of receive chains to process signals received from the antennas ANT1-ANTn. Thus, the AP 200 may be configured for MIMO communications and OFDMA communications. The MIMO communications may include SU-MIMO communications and MU-MIMO communications. In some implementations, the AP 200 may use multiple antennas ANT1-ANTn to provide antenna diversity. Antenna diversity may include polarization diversity, pattern diversity, and spatial diversity.

The network interface 240, which is coupled to the processor 220, may be used to communicate with the system controller 130 of FIG. 1. The network interface 240 also may allow the AP 200 to communicate, either directly or via one or more intervening networks, with other wireless systems, with other APs, with one or more back-haul networks, and so on.

The memory 230 may include a database 231 that may store location data, configuration information, data rates, MAC addresses, timing information, modulation and coding schemes, ranging capabilities, and other suitable information about (or pertaining to) a number of other wireless devices. The database 231 also may store profile information for a number of other wireless devices. The profile information for a given wireless device may include, for example, a service set identification (SSID) for the wireless device, a Basic Service Set Identifier (BSSID), operating channels, TSF values, beacon intervals, ranging schedules, channel state information (CSI), received signal strength indicator (RSSI) values, goodput values, connection history with the AP 200, and previous ranging operations with the AP 200. In some implementations, the profile information for a given wireless device also may include clock offset values, carrier frequency offset values, and ranging capabilities. The memory 230 also may include a non-transitory computer-readable storage medium (such as one or more nonvolatile memory elements, such as EPROM, EEPROM, Flash memory, a hard drive, and so on) that may store the following software modules:
a frame exchange software module 232 to create and exchange ranging frames (such as polling frames and trigger frames), measurement frames (such as Fine Timing Measurement (FTM) frames, null data packet announcements (NDPAs), and null data packets (NDPs)), reporting frames (such as location measurement reports (LMRs) and feedback frames), and other frames (such as data frames, control frames, and management frames) between the AP 200 and other wireless devices, for example, as described with respect to FIGS. 5A-5B, 6A-6B, 7A-7B, 8, 9A-9C, and 10;
a ranging software module 233 to negotiate and perform ranging operations with other wireless devices, for example, as described with respect to FIGS. 5A-5B, 6A-6B, 7A-7B, 8, 9A-9C, and 10;
a carrier frequency offset (CFO) determination software module 234 to determine a CFO value between the AP 200 and each of a number of other wireless devices, for example, as described with respect to FIGS. 5A-5B, 6A-6B, 7A-7B, 8, 9A-9C, and 10;
a timestamp software module 235 to capture or record timestamps of signals received by the AP 200 (such as Time of Arrival (TOA) information), to capture or record timestamps of signals transmitted from the AP 200 (such as Time of Departure (TOD) information), and to adjust or correct timestamps to compensate for clock offsets between the AP 200 and one or more other wireless devices, for example, as described with respect to 5A-5B, 6A-6B, 7A-7B, 8, 9A-9C, and 10; and
a measurement software module 236 to determine one or more RTT values based on a number of timestamps, to determine the location of one or more other wireless devices, and to share location information of the AP 200 with other wireless devices, as described with respect to FIGS. 5A-5B, 6A-6B, 7A-7B, 8, 9A-9C, and 10.
   Each software module includes instructions that, when executed by the processor 220, may cause the AP 200 to perform the corresponding functions. The non-transitory computer-readable medium of the memory 230 thus includes instructions for performing all or a portion of the operations described with respect to FIGS. 5A-5B, 6A-6B, 7A-7B, 8, 9A-9C, and 10.

The processor 220 may be any one or more suitable processors capable of executing scripts or instructions of one or more software programs stored in the AP 200 (such as within the memory 230). The processor 220 may execute the frame exchange software module 232 to create and exchange ranging frames (such as polling frames and trigger frames), measurement frames (such as FTM frames, NDPAs, and NDPs), reporting frames (such as LMRs and feedback frames), and other frames (such as data frames, control frames, and management frames) between the AP 200 and other wireless devices.

The processor 220 may execute the ranging software module 233 to negotiate and perform ranging operations with other wireless devices. In some implementations, the ranging operations may include Fine Timing Measurement (FTM) ranging operations, High-Efficiency (HE) ranging operations, Very High Throughput (VHT) ranging operations, Extremely High Throughput (EHT), directional multi-gigabit (DMG) ranging operations, and enhanced directional multi-gigabit (EDMG) ranging operations.

The processor 220 may execute the CFO determination software module 234 to determine a CFO value between the AP 200 and each of a number of other wireless devices. In some implementations, the CFO value may be indicative of a difference between the carrier frequency generated by the AP 200 and the carrier frequency generated by the other wireless device, and also may be indicative of a clock offset between the AP 200 and the other wireless device.

The processor 220 may execute the timestamp software module 235 to capture or record timestamps of signals received by the AP 200 (such as TOA information), to capture or record timestamps of signals transmitted from the AP 200 (such as TOD information), and to adjust or correct timestamps to compensate for clock offsets between the AP 200 and one or more other wireless devices.

The processor 220 may execute the measurement software module 236 to determine one or more RTT values based on a number of timestamps, to determine the location of one or more other wireless devices, and to share location information of the AP 200 with other wireless devices. In some implementations, the processor 220 also may execute the measurement software module 236 to estimate angle information of frames exchanged with other wireless devices. The angle information may include angle of arrival (AoA) information and angle of departure (AoD) information).

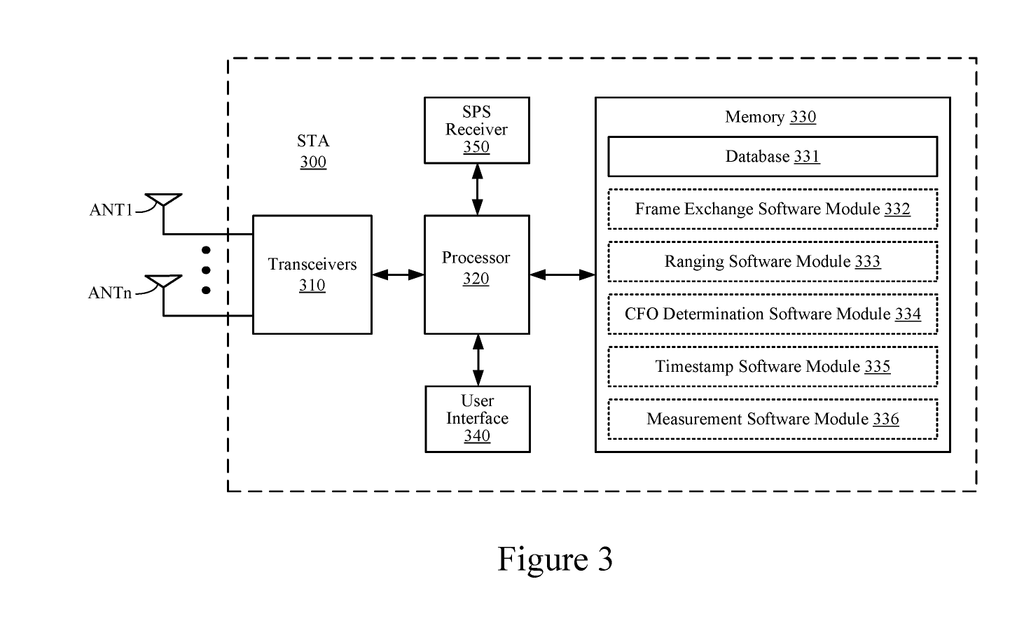

FIG. 3 shows an example wireless station (STA) 300. The STA 300 may be one implementation of at least one of the STAs 120a-120i of FIG. 1. The STA 300 may include one or more transceivers 310, a processor 320, a memory 330, a user interface 340, and a number of antennas ANT1-ANTn. The transceivers 310 may be coupled to antennas ANT1-ANTn, either directly or through an antenna selection circuit (not shown for simplicity). The transceivers 310 may be used to transmit signals to and receive signals from other wireless devices including, for example, a number of APs and a number of other STAs. Although not shown in FIG. 3 for simplicity, the transceivers 310 may include any number of transmit chains to process and transmit signals to other wireless devices via antennas ANT1-ANTn, and may include any number of receive chains to process signals received from antennas ANT1-ANTn. Thus, the STA 300 may be configured for MIMO communications and OFDMA communications. The MIMO communications may include SU-MIMO communications and MU-MIMO communications. In some implementations, the STA 300 may use multiple antennas ANT1-ANTn to provide antenna diversity. Antenna diversity may include polarization diversity, pattern diversity, and spatial diversity.

The user interface 340, which is coupled to the processor 320, may be or represent a number of suitable user input devices such as, for example, a speaker, a microphone, a display device, a keyboard, a touch screen, and so on. In some implementations, the user interface 340 may allow a user to control a number of operations of the STA 300, to interact with one or more applications executable by the STA 300, and other suitable functions.

In some implementations, the STA 300 may include a satellite positioning system (SPS) receiver 350. The SPS receiver 350, which is coupled to the processor 320, may be used to acquire and receive signals transmitted from one or more satellites or satellite systems via an antenna (not shown for simplicity). Signals received by the SPS receiver 350 may be used to determine (or at least assist with the determination of) a location of the STA 300.

The memory 330 may include a database 331 that may store location data, configuration information, data rates, MAC addresses, timing information, modulation and coding schemes, ranging capabilities, and other suitable information about (or pertaining to) a number of other wireless devices. The database 331 also may store profile information for a number of other wireless devices. The profile information for a given wireless device may include, for example, an SSID of the wireless device, a BSSID or MAC Address, operating channels, TSF values, beacon intervals, ranging schedules, CSI, RSSI values, goodput values, and previous ranging operations with the STA 300. In some implementations, the profile information for a given wireless device also may include clock offset values, carrier frequency offset values, and ranging capabilities.

The memory 330 also may include a non-transitory computer-readable storage medium (such as one or more nonvolatile memory elements, such as EPROM, EEPROM, Flash memory, a hard drive, and so on) that may store the following software modules:
a frame exchange software module 332 to create and exchange ranging frames (such as FTM request frames, polling response frames, and acknowledgement (ACK) frames), measurement frames (such as FTM measurement frames, UL MU data frames, and UL MU NDPs), reporting frames (such as LMRs and feedback frames), and other frames (such as data frames, control frames, and management frames) between the STA 300 and other wireless devices, for example, as described with respect to FIGS. 5A-5B, 6A-6B, 7A-7B, 8, 9A-9C, and 10;
a ranging software module 333 to negotiate and perform ranging operations with other wireless devices, for example, as described with respect to FIGS. 5A-5B, 6A-6B, 7A-7B, 8, 9A-9C, and 10;
a CFO determination software module 334 to determine a carrier frequency offset value between the STA 300 and another wireless device, for example, as described with respect to FIGS. 5A-5B, 6A-6B, 7A-7B, 8, 9A-9C, and 10;
a timestamp software module 335 to capture or record timestamps of signals received by the STA 300 (such as TOA information), to capture or record timestamps of signals transmitted from the STA 300 (such as TOD information), and to adjust or correct timestamps to compensate for clock offsets between the STA 300 and one or more other ranging devices, for example, as described with respect to FIGS. 5A-5B, 6A-6B, 7A-7B, 8, 9A-9C, and 10; and
a measurement software module 336 to determine one or more RTT values based on a number of timestamps, to determine the location of one or more other wireless devices, and to share location information of the STA 300 with other wireless devices, for example, as described with respect to FIGS. 5A-5B, 6A-6B, 7A-7B, 8, 9A-9C, and 10.
   Each software module includes instructions that, when executed by the processor 320, may cause the STA 300 to perform the corresponding functions. The non-transitory computer-readable medium of the memory 330 thus includes instructions for performing all or a portion of the operations described with respect to FIGS. 5A-5B, 6A-6B, 7A-7B, 8, 9A-9C, and 10.

The processor 320 may be any one or more suitable processors capable of executing scripts or instructions of one or more software programs stored in the STA 300 (such as within the memory 330). The processor 320 may execute the frame exchange software module 332 to create and exchange ranging frames (such as FTM request frames, polling response frames, and ACK frames), measurement frames (such as FTM measurement frames, UL MU data frames, and UL MU NDPs), reporting frames (such as LMRs and feedback frames), and other frames (such as data frames, control frames, and management frames) between the STA 300 and other wireless devices.

The processor may execute the ranging software module 333 to negotiate and perform ranging operations with other wireless devices. In some implementations, the ranging operations may include FTM ranging operations, HE ranging operations, VHT ranging operations, DMG ranging operations, and EDMG ranging operations.

The processor 320 may execute the CFO determination software module 334 to determine a carrier frequency offset value between the STA 300 and another wireless device. In some implementations, the CFO value may be indicative of a difference between the carrier frequency generated by the STA 300 and the carrier frequency generated by the other wireless device, and also may be indicative of a clock offset between the STA 300 and the other wireless device.

The processor 320 may execute the timestamp software module 335 to capture or record timestamps of signals received by the STA 300 (such as TOA information), to capture or record timestamps of signals transmitted from the STA 300 (such as TOD information), and to adjust or correct timestamps to compensate for clock offsets between the STA 300 and one or more other ranging devices.

The processor 320 may execute the measurement software module 336 to determine one or more RTT values based on a number of timestamps, to determine the location of one or more other wireless devices, and to share location information of the STA 300 with other wireless devices. In some implementations, the processor 320 also may execute the measurement software module 336 to estimate angle information of frames exchanged with other wireless devices (such as AoA information and AoD information).

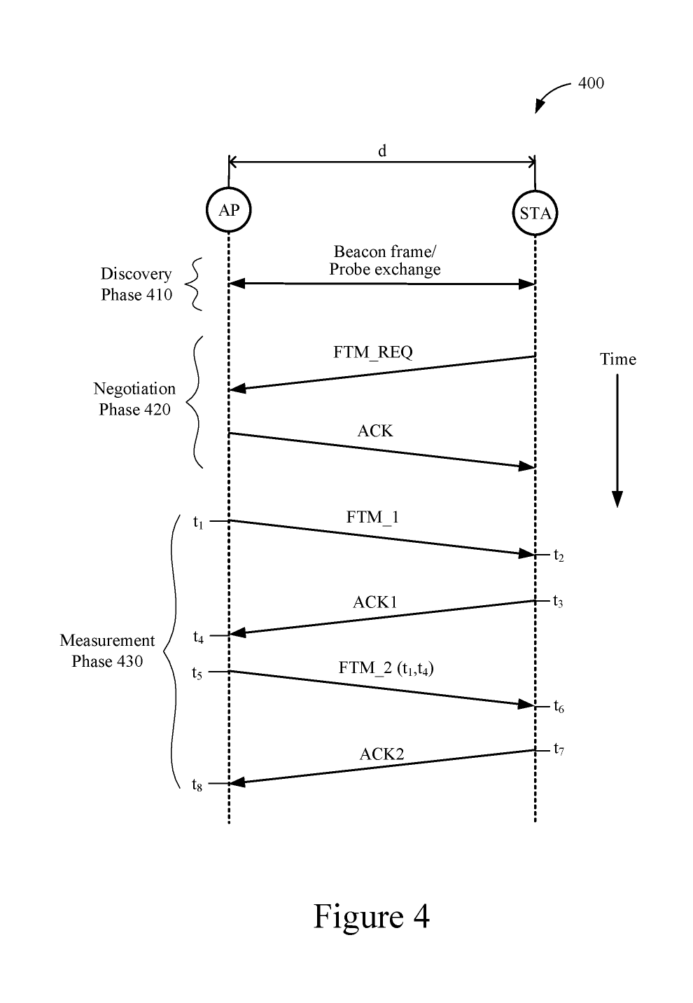

FIG. 4 shows a signal diagram of an example ranging operation 400. The example ranging operation 400 is performed between a wireless station (STA) and an access point (AP) using Fine Timing Measurement (FTM) frames in accordance with the IEEE 802.11REVmc standards. For the example of FIG. 4, the STA requests the ranging operation, and may be referred to as the initiator device (or alternatively the requestor device). The AP responds to the request, and may be referred to as the responder device. It is to be understood that any suitable wireless device can be the initiator device, and that any suitable wireless device can be the responder device.

The ranging operation 400 may include a discovery phase 410, a negotiation phase 420, and a measurement phase 430. During the discovery phase 410, the STA may discover other wireless devices within range of the STA that support ranging operations. In some implementations, the STA may discover the AP in an active manner, for example, by transmitting a probe request to the AP. The AP may respond by transmitting a probe response that indicates whether the AP supports FTM ranging operations. In some other implementations, the STA may discover the AP in a passive manner, for example, by receiving a beacon frame from the AP. The beacon frame may indicate whether the AP supports FTM ranging operations. In some other implementations, the STA may discover the AP using out-of-band signaling such as, for example, Bluetooth Low Energy (BLE) messages.

During the negotiation phase 420, the STA and the AP may exchange information and negotiate a number of ranging parameters and capabilities such as, for example, a capability of capturing timestamping, a capability of estimating angle information, a frame format to be used for exchanging ranging frames, a bandwidth with which to transmit ranging frames, a duration of the ranging operation, a periodicity of the ranging operation, a number of frame exchanges or “bursts” for each ranging operation, and so on.

The STA may initiate the negotiation phase 420 by transmitting an FTM request (FTM_REQ) frame to the AP. In addition to signaling or requesting the ranging operation 400, the FTM_REQ frame may request the number of ranging parameters and capabilities. The AP receives the FTM_REQ frame, and may acknowledge the requested ranging operation by transmitting an acknowledgement (ACK) frame to the STA. The ACK frame may indicate capabilities of the AP (such as whether the AP is capable of capturing timestamps, capable of transmitting in the requested frame format and bandwidth, and so on), and may accept a number of the ranging parameters requested by the STA.

During the measurement phase 430, the STA and the AP may perform measurement exchanges by exchanging a number of frames or packets. If both the AP and the STA support the FTM protocol, then the measurement phase 430 may be performed by exchanging a number of FTM frames. In some aspects, at time t₁, the AP transmits an FTM _1 frame to the STA and may capture the TOD of the FTM _1 frame as time t₁. The STA receives the FTM _1 frame at time t₂, and may capture the TOA of the FTM _1 frame as time t₂. The STA responds by transmitting a first acknowledgement (ACK1) frame to the AP at time t₃ and may capture the TOD of the ACK1 frame as time t₃. The AP receives the ACK1 frame at time t₄, and may capture the TOA of the ACK1 frame as time t₄. At time t₅, the AP transmits, to the STA, an FTM_2 frame that includes the timestamps captured at times t₁ and t₄ (such as the TOD of the FTM _1 frame and the TOA of the ACK1 frame). The STA receives the FTM_2 frame at time t₆, and may capture its timestamp as time t₆.

Upon receiving the FTM_2 frame at time t₆, the STA has timestamp values for times t₁, t₂, t₃, and t₄ that correspond to the TOD of the FTM _1 frame transmitted from the AP, the TOA of the FTM 1 frame at the STA, the TOD of the ACK1 frame transmitted from the STA, and the TOA of the ACK1 frame at the AP, respectively. Thereafter, the STA may determine an RTT value as RTT=(t₄−t₃)+(t₂−t₁). Because the value of RTT does not involve estimating a Short Interframe Space (SIFS) for either the STA or the AP, the value of RTT does not involve errors resulting from uncertainties in SIFS durations.

Wi-Fi ranging operations may be performed using frames transmitted as orthogonal frequency-division multiplexing (OFDM) symbols. The accuracy of RTT estimates may be proportional to the number of tones (such as the number of OFDM sub-carriers) used to transmit the ranging frames. In some aspects, while a legacy frame may be transmitted on a 20 MHz-wide channel using 52 tones, a high-throughput (HT) frame or a very high-throughput (VHT) frame may be transmitted on a 20 MHz-wide channel using 56 tones, and a high-efficiency (HE) frame may be transmitted on a 20 MHz-wide channel using 242 tones. Thus, for a given frequency bandwidth or channel width, HT/VHT/HE frames use more tones than non-HT frames, and may therefore provide more accurate channel estimates and RTT estimates than non-HT frames.

In some implementations, the AP may use a trigger frame to solicit uplink (UL) data (such as MU-MIMO data) from a number of wireless devices identified in the trigger frame. The trigger frame may indicate or specify an order in which the identified wireless devices are to transmit UL data to the AP. In some implementations, multiple wireless devices identified in the trigger frame may transmit UL MU-MIMO data frames to the AP. In some other implementations, multiple wireless devices identified in the trigger frame may transmit null data packets (NDPs) to the AP. The NDPs may be transmitted as either SU-NDPs or MU-NDPs.

One or more IEEE specifications (such as, but not limited to, the IEEE 802.11ax specification, or 802.11-EHT specification) may introduce multiple access mechanisms, such as an orthogonal frequency-division multiple access (OFDMA) mechanism, to allow multiple STAs to transmit and receive data on a shared wireless medium at the same time. For a wireless network using OFDMA, the available frequency spectrum may be divided into a plurality of resource units (RUs) each including a number of different frequency subcarriers, and different RUs may be allocated or assigned (such as by an AP) to different wireless devices (such as STAs) at a given point in time. An AP may use a trigger frame to allocate specific RUs to a number of wireless devices identified in the trigger frame. The trigger frame may indicate the RU size and location, the Modulation and Coding Scheme (MCS), and the power level to be used by the identified wireless devices for UL data transmissions using OFDMA. In this manner, multiple wireless devices may concurrently transmit data on the wireless medium using their assigned RUs or frequency subcarriers.

FIG. 5A shows a signal diagram of an example ranging operation 500, and FIG. 5B shows a sequence diagram 510 of the example ranging operation 500 of FIG. 5A. The ranging operation 500 is performed between an access point (AP) and two groups of stations STA_{A1}-STA_{An} and STA_{B1}-STA_{Bn}. For simplicity, the first group of stations STA_{A1}-STA_{An} may be referred to herein as the first stations STA_A, and the second group of stations STA_{B1}-STA_{Bn} may be referred to herein as the second stations STA_B. In the example of FIGS. 5A-5B, the AP is the responder device, and the stations STA_A and STA_B are the initiator devices. The AP may be any suitable AP including, for example, the AP 110 of FIG. 1 or the AP 200 of FIG. 2. Each of the stations STA_A and STA_B may be any suitable station including, for example, one of the STAs 120a-120i of FIG. 1 or the STA 300 of FIG. 3. Although two groups of stations STA_A and STA_B are shown in the example of FIGS. 5A-5B, in some other implementations, any number of groups of stations may participate in the example ranging operation 500.

The example ranging operation 500 may include three phases or parts: measurement polling, measurement sounding, and location measurement reporting. The measurement polling may be used to identify each of the initiator devices that will participate in the ranging operation. The measurement sounding may be used to exchange a number of sounding sequences between the responder device and the participating initiator devices. The location measurement reporting may be used to provide timestamps captured or determined by the participating initiator devices to the responder device, and may be used to provide timestamps captured or determined by the responder device to the participating initiator devices.

Wireless devices typically use the same clock to capture timestamps and to generate a carrier frequency for data transmissions. Thus, clock offsets between the responder device AP and the initiator devices STA_A and STA_B may result in a carrier frequency offset (CFO) between the responder device AP and one or more of the initiator devices STA_A and STA_B. Similarly, clock offsets between the initiator devices STA_A and STA_B may result in carrier frequency offsets (CFOs) between the initiator devices STA_A and STA_B. An initiator device may use the reception of DL data frames from the responder device AP to estimate the CFO between itself and the responder device AP, and may adjust its transmit carrier frequency based on the estimated CFO so that UL data transmissions from the initiator device have the same (or least very similar) carrier frequency as the carrier frequency used by the responder device AP.

The initiator devices STA_A and STA_B may use estimated CFOs to frequency-correct UL data transmissions during the example ranging operation 500, for example, so that UL data (such as MU UL NDPs) from different initiator devices is transmitted to the responder device AP using the same (or at least substantially similar) carrier frequency used by the responder device AP. Synchronizing the actual transmit carrier frequencies used by the initiator devices STA_A and STA_B with the carrier frequency of the responder device AP may allow the responder device AP to more easily receive and down-convert UL data transmitted from different initiator devices.

Although the responder device AP may estimate the CFO between itself and an initiator device based on UL data received from the initiator device, the initiator device may have adjusted its transmit carrier frequency to compensate for carrier frequency offsets with respect to the responder device AP. As such, the responder device AP may not be able to determine the CFO between its own carrier frequency and the unadjusted carrier frequency of the initiator device based on UL data frames received from the initiator device. Therefore, the responder device AP may not be able to determine the clock offset between itself and the initiator device. In some implementations, the initiator devices STA_A and STA_B may report their estimated CFO values to the responder device AP, for example, so that the responder device AP can derive the clock offset between itself and each of the initiator devices STA_A and STA_B based on the estimated CFO values.

The measurement polling begins at time to, and the responder device AP transmits a poll trigger frame (Poll Trigger) to solicit measurement requests from nearby initiator devices (such as the stations STA_A and STA_B). Each of the stations STA_A and STA_B that receives the poll trigger frame may respond by transmitting a ranging poll response frame (Poll Resp) to the responder device AP. In some implementations, the ranging poll response frames are transmitted to the responder device AP after a SIFS duration. Each of the ranging poll response frames may request the responder device to commence a measurement sounding for a corresponding one of the initiator devices.

The responder device AP receives the ranging poll response frames, and may allocate measurement resources and location measurement results to the participating initiator devices based on the received ranging poll response frames. In some implementations, the responder device AP may use the received ranging poll response frames to divide the responding stations into groups (such as the first stations STA_A and the second stations STA_B) for UL transmissions. The measurement polling may end when the responder device AP receives the ranging poll response frames.

The measurement sounding begins when the responder device AP transmits a first UL trigger frame to solicit UL data transmissions from a first group of initiator devices. For the example of FIGS. 5A and 5B, the first UL trigger frame solicits a number of the first stations STA_A to transmit an UL NDP to the responder device AP. The first UL trigger frame may identify associated stations using their assigned AID values, and may identify unassociated stations using ranging ID (RID) values. In some implementations, the first UL trigger frame may allocate a separate time, frequency, and spatial stream to each of the identified number of first stations STA_A.

At time t_{1A}, each of the first stations STA_A identified in the first UL trigger frame transmits an UL NDP to the responder device AP and captures the TOD of the UL NDP as time t_{1A}. Each of the identified first stations STA_A may use its own clock to capture a timestamp for time t_{1A}. In some implementations, the clocks of the first stations STA_A may be different from one another, and also may be different than the clock of the responder device AP. The first UL NDPs may be transmitted from the first stations STA_A to the responder device AP as UL MU-NDPs. The first UL MU-NDPs may include a number of sounding sequences from which multiple RTT values may be obtained (and from which channel conditions may be estimated). The sounding sequences contained in the first UL MU-NDPs may be high-efficiency long training fields (HE-LTFs), very high-throughput long training fields (VHT-LTFs), high-throughput long training fields (HT-LTFs), or legacy LTFs, and may be orthogonal to each other.

The responder device AP receives the first UL MU-NDPs transmitted from the first stations STA_A at time t_{2A} and captures the TOAs of the first UL MU-NDPs. For simplicity, the TOAs of the first UL MU-NDPs received at the responder device AP are collectively shown as time t_{2A} in the example of FIGS. 5A and 5B. A person having ordinary skill in the art will readily understand that, in actual implementations, the first UL MU-NDPs may have slightly different TOAs. In some implementations, the responder device AP may estimate angle information based on the sounding sequences contained in the first UL MU-NDPs.

The responder device AP transmits a second UL trigger frame to solicit UL data transmissions from a second group of initiator devices. For the example of FIGS. 5A and 5B, the second UL trigger frame solicits a number of the second stations STA_B to transmit an UL NDP to the responder device AP. The second UL trigger frame may identify associated stations using their assigned AID values, and may identify unassociated stations using RID values. In some implementations, the second UL trigger frame may allocate a separate time, frequency, and spatial stream to each of the identified number of second stations STA_B.

At time t_{1B}, each of the second stations STA_B identified in the second UL trigger frame transmits an UL NDP to the responder device AP and captures the TOD of the UL NDP as time t_{1B}. Each of the identified second stations STA_B may use its own clock to capture a timestamp for time t_{1B}. In some implementations, the clocks of the second stations STA_B may be different from one another, may be different from the clocks of the first stations STA_A, and also may be different than the clock of the responder device AP. The second UL NDPs may be transmitted from the second stations STA_B to the responder device AP as UL MU-NDPs, and may include a number of sounding sequences from which multiple RTT values may be obtained (and from which channel conditions may be estimated). The sounding sequences contained in the second UL MU-NDPs may be HE-LTFs, VHT-LTFs, HT-LTFs, or legacy LTFs, and may be orthogonal to each other. In some implementations, the second UL NDPs transmitted from the second stations STA_B may be passively received by the first stations STA_A at time t_{AB}. Each of the first stations STA_A may capture a timestamp for time t_{AB} using its own clock.

The responder device AP receives the second UL MU-NDPs transmitted from the second stations STA_B at time t_{2B} and captures the TOAs of the second UL MU-NDPs. For simplicity, the TOAs of the second UL MU-NDPs received at the responder device AP are collectively shown as time t_{2B} in the example of FIGS. 5A and 5B. A person having ordinary skill in the art will readily understand that, in actual implementations, the second UL MU-NDPs may have slightly different TOAs. In some implementations, the responder device AP may estimate angle information based on the sounding sequences contained in the second UL MU-NDPs.

The responder device AP transmits a downlink null data packet announcement (DL NDPA) to the initiator devices STA_A and STA_B. The DL NDPA may inform the initiator devices STA_A and STA_B to listen for an NDP to be transmitted from the responder device AP.

At time t₃, which may be a SIFS duration after transmission of the NDPA, the responder device AP transmits a DL NDP to the initiator devices STA_A and STA_B and records the TOD of the DL NDP as time t₃. The responder device AP may use its own clock to capture timestamps for times t₂ and t₃ (such as without frequency offset corrections). The DL NDP may include a number of sounding sequences from which multiple RTT values may be obtained (and from which channel conditions may be estimated). The sounding sequences contained in the DL NDP may be HE-LTFs, VHT-LTFs, HT-LTFs, or legacy LTFs, and may be orthogonal to each other. In some other implementations, the DL NDP also may include the NDPA. In some implementations, the DL NDP may be used by all initiator devices STA_A and STA_B, for example, by transmitting the DL NDP using an entire bandwidth of the wireless medium.

Each of the initiator devices STA_A and STA_B receives the DL NDP at time t₄ and captures the TOA of the DL NDP as time t₄. Each of the initiator devices STA_A and STA_B may use its own clock to capture a timestamp for time t₄. In some implementations, the clocks of the initiator devices STA_A and STA_B may be different from one another. For simplicity, the TOAs of the DL NDP at the initiator devices STA_A and STA_B are collectively shown as time t₄ in the example of FIG. 5A. A person having ordinary skill in the art will readily understand that, in actual implementations, the DL NDPs may have slightly different TOAs at the initiator devices STA_A and STA_B. In some implementations, the initiator devices STA_A and STA_B may estimate angle information based on the sounding sequences contained in the DL NDP. The measurement sounding may end upon reception of the DL NDP by the initiator devices STA_A and STA_B.

In some implementations, the initiator devices STA_A and STA_B may compensate for clock offsets relative to the responder device AP by estimating carrier frequency offsets relative to the responder device AP that can be used to adjust the captured timestamps. In some aspects, each of the initiator devices STA_A and STA_B may use its estimated carrier frequency offset to adjust the captured timestamps for times t₁ and t₄ to generate corrected timestamps t₁′ and t₄′. In some implementations, each of the initiator devices STA_A and STA_B may use the estimated CFO value between itself and the responder device AP to generate the corrected timestamps, which may be used to determine RTT values between the responder device AP and each of the initiator devices STA_A and STA_B. The initiator devices STA_A and STA_B may report the corrected timestamps to the responder device AP using any suitable uplink transmission. In other implementations, the initiator devices STA_A and STA_B may report their captured timestamps and estimated CFO values to the responder device AP using any suitable uplink transmission.

In some implementations, a device (such as an initiator device) may select one of the timestamps t₁-t₄ as a reference timestamp (t_{REF}), and may adjust the other timestamps relative to the reference timestamp to generate a set of corrected timestamps. In some implementations, the device may adjust captured timestamps using the expression:

tₖ′=tₖ−(tₖ−t_{REF})*CFO_{TX},

where t_{REF} is the reference timestamp, tₖ is the captured timestamp, tₖ′ is the corrected timestamp, and CFO_{TX} is the carrier frequency offset between the initiator device and the responder device AP (expressed as a fraction having a value between 0 and 1).

In some implementations, the earliest timestamp reported between the responder device AP and the initiator devices STA_A and STA_B may be selected as the reference timestamp. In other implementations, any one of the other timestamps may be selected as the reference timestamp, such as when the selection of a particular timestamp as the reference timestamp is stored. For the example of FIGS. 5A and 5B, the first timestamp t₁ is the earliest timestamp reported in the ranging operation 500, and may be selected as the reference timestamp t_{REF}. The first timestamp t₁ may be determined using one of the following operations:
the initiator device captures the timestamp for t₁ using a continuously running clock and reports the timestamp for t₁ to the responder device AP (such as in the UL LMR frame);
the timestamp for t₁ is assumed to have a zero value, thereby obviating the need for the initiator device to report the timestamp for t₁ to the responder device AP (which may reduce the size of the UL LMR frame); or
the initiator device reports the timestamp for t₁ to the responder device AP as an arbitrary value (such as by using a clock or counter that resets after every Transmit Opportunity (TXOP)).

In some aspects, if the timestamp for t₁ is selected as the reference value t_{REF} and set to a zero value (such as t₁=0), the corrected timestamp for t₂ may be calculated as t₂′=t₂−t₂−t_{REF})*CFO_{TX}=t₂′=t₂−t₂*CFO_{TX}. Similarly, the corrected timestamp for t₃ may be calculated as t₃′=t₃−(t₃−t_{REF})*CFO_{TX}=t₃′=t₃−t₃*CFO_{TX}.

The location measurement reporting begins at time t₅ when the responder device AP transmits a downlink location measurement report (DL LMR) frame. In some implementations, the responder device AP may transmit a first DL LMR frame that includes timestamp values for time t_{2A} and time t₃ (corresponding to the TOAs of the first MU UL NDPs at the responder device AP and to the TOD of the DL NDP transmitted from the responder device AP, respectively). In some implementations, the responder device AP may transmit a second DL LMR frame that includes timestamp values for time t_{2B} and time t₃ (corresponding to the TOAs of the second MU UL NDPs received at the responder device AP and to the TOD of the DL NDP transmitted from the responder device AP, respectively). In some other implementations, the first and second DL LMR frames may be transmitted as a MU LMR frame.

Upon reception of the DL LMR frame, each of the initiator devices STA_A and STA_B has timestamp values for t₁, t₂, t₃, and t₄ (as well as the corrected timestamps t₁′ and t₄′). Each of the initiator devices may determine the RTT between itself and the responder device AP using the expression RTT=(t₄′−t₃)+(t₂−t₁′). In some aspects, the first stations STA_A may determine RTT values using the expression RTT=(t₄′−t₃)+(t_{2A}−t_{1A}′), and the second stations STA_B may determine RTT values using the expression RTT=(t₄′−t₃)+(t_{2B}−t_{1B}′).

At time t₆, the responder device AP transmits a LMR trigger frame to the initiator devices STA_A and STA_B. The LMR trigger frame may solicit a number of the initiator devices STA_A and STA_B to transmit UL LMR frames to the responder device AP. In some implementations, each of the UL LMR frames may include the corrected timestamps and t₄′(rather than the captured timestamps t₁ and t₄ or the estimated carrier frequency offset values). Upon reception of the UL LMR frames, the responder device AP has timestamp values for t₁′, t₂, t₃, and t₄′, and may determine the RTT between itself and each of the initiator devices STA_A and STA_B using the expression RTT=(t₄′−t₃)+(t₂−t₁′). RTT values determined using the corrected timestamps t₁′ and t₄′ may be more accurate than RTT values determined using the captured timestamps t₁ and t₄, for example, because the corrected timestamps t₁′ and t₄′ compensate for clock offsets between the initiator device and the responder device AP. Also, by reporting the corrected timestamps to the responder device AP in the UL LMR frames, the initiator devices STA_A and STA_B may not need to report their estimated carrier frequency offset values to the responder device AP in the UL LMR frames, thereby reducing the size and transmit duration of the UL LMR frames.

In addition, or in the alternative, each of the first stations STA_A may report its t_{AB} to the responder device AP in the UL LMR frame.

In some implementations, the size of the DL LMR frame may be reduced by reporting a value indicative of the difference between times t₃ and t₂ (such as t_{diff32}=t₃−t₂) rather than by reporting individual timestamps for each of times t₂ and t₃. In some aspects, if each of the timestamps for t₂ and t₃ is 48 bits long and the difference value (t_{diff32}) is also 48 bits long, then reporting the difference value rather than the individual timestamps for t₂ and t₃ may reduce the size of the DL LMR frame by 48 bits, albeit at the cost of reduced accuracy. Similarly, the size of each UL LMR frame may be reduced by reporting a value indicative of the difference between times t₄′− t₁′ (such as t_{diff41}=t₄′−t₁′) rather than by reporting the individual timestamps for each of t₁′ and t₄′. In some aspects, if each of the timestamps for t₁′ and t₄′ is 48 bits long and the difference value (t_{diff41}) is also 48 bits long, then reporting the difference value t_{diff41} rather than the individual timestamps for t₁′ and t₄′ may reduce the size of each UL LMR frame by 48 bits, albeit at the cost of reduced accuracy.

In addition, or in the alternative, the responder device AP and the initiator devices STA_A and STA_B may use relative time values (rather than absolute time values obtained from a continuous clock) to indicate timestamps for times t₁, t₂, t₃, and t₄. In some implementations, the timestamp for time t₁ (corresponding to the TOD of the MU UL NDP) may be set to a zero value (0) and used as a reference value. Subsequent timestamps (such as for each of times t₂, t₃, and t₄) may be referenced or indexed from the reference value. Using relative time values indicative of times t₁, t₂, t₃, and t₄ may reduce the number of bits in LMR frames used for exchanging timestamps between the responder device AP and the initiator devices STA_A and STA_B, for example, as compared with using absolute time values indicative of times t₁, t₂, t₃, and t₄. In some other implementations, another suitable timestamp (such as the earliest timestamp contained in the LMR frames) may be used as the reference value.

In some implementations, the difference value (t_{diff_41}) indicative of t₄−t₁ may be adjusted based on a value of CFO_{TX} to generate a corrected difference value t_{diff_41}′=t₄′−t₁′ that compensates for clock offsets between the responder device AP and an initiator device. The initiator device may report the corrected difference value t_{diff_41}′ to the responder device AP in a UL LMR frame. In some implementations, the value of CFO_{TX} also may be reported to the responder device AP in the UL LMR frame.

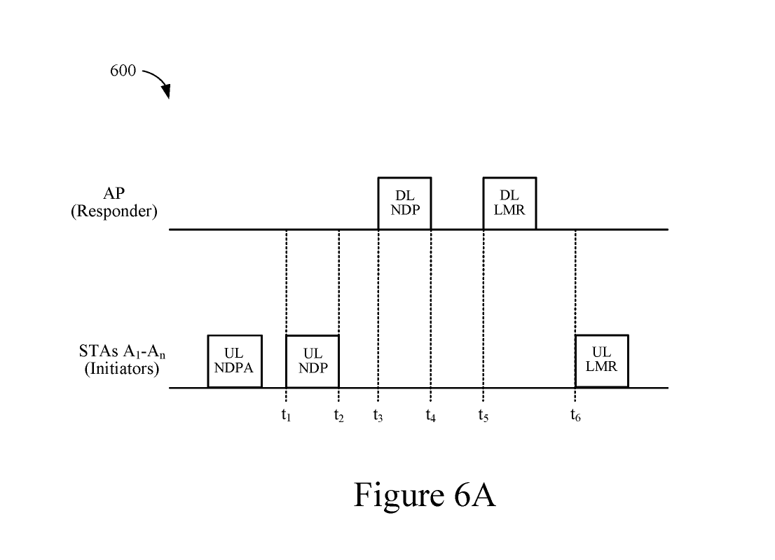

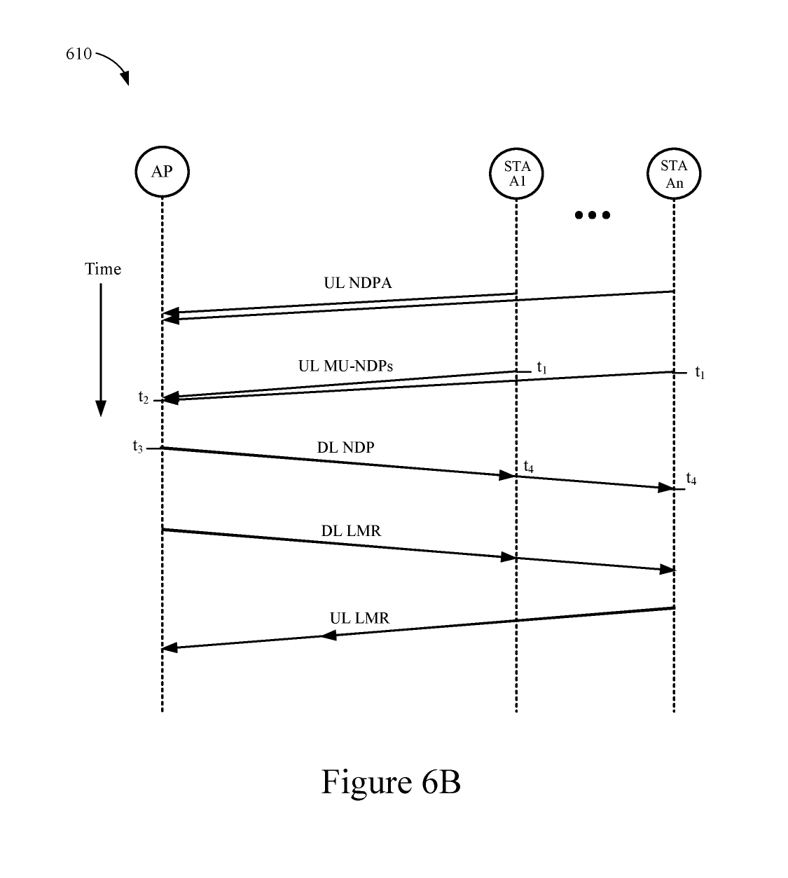

FIG. 6A shows a signal diagram of another example ranging operation 600, and FIG. 6B shows a sequence diagram 610 of the example ranging operation 600 of FIG. 6A. The ranging operation 600 is performed between the responder device AP and a group of initiator devices STA_A using VHT timestamps. The AP may be any suitable AP including, for example, the AP 110 of FIG. 1 or the AP 200 of FIG. 2. Each of the stations STA_A may be any suitable station, for example, one of the STAs 120a-120i of FIG. 1 or the STA 300 of FIG. 3. Although one group of stations STA_A is shown in the example of FIGS. 6A-6B, in some other implementations, any number of groups of stations may participate in the example ranging operation 600.

At time to, the initiator devices STA_A transmit an UL NDPA to the responder device AP. The UL NDPA may alert the responder device AP that the initiator devices STA_A are to transmit an UL NDP to the responder device AP.

At time t₁, the initiator devices STA_A transmit an UL NDP to the responder device AP and capture the TOD of the UL NDP as time t₁. The responder device AP receives the UL NDP at time t₂, and captures the TOA of the UL NDP as time t₂. The UL NDP may include a number of sounding sequences from which multiple RTT values may be obtained (and from which channel conditions may be estimated). The sounding sequences contained in the UL NDP may be HE-LTFs, VHT-LTFs, HT-LTFs, or legacy LTFs, and may be orthogonal to each other.

At time t₃, the responder device AP transmits a DL NDP and captures the TOA of the DL NDP as time t₃. The responder device AP may use its own clock for capturing timestamps for times t₂ and t₃ (such as without frequency offset corrections). In some implementations, the DL NDP may be used by all initiator devices STA_A and STA_B, for example, by transmitting the DL NDP using an entire bandwidth of the wireless medium.

At time t₄, the initiator devices STA_A receive the DL NDP and capture the TOA of the DL NDP as time t₄. The DL NDP may include a number of sounding sequences from which multiple RTT values may be obtained (and from which channel conditions may be estimated). The sounding sequences contained in the DL NDP may be HE-LTFs, VHT-LTFs, HT-LTFs, or legacy LTFs, and may be orthogonal to each other.

At time t₅, the responder device AP transmits a DL LMR frame, which may include timestamps for t₂ and t₃ captured by the responder device AP. At time t₆, the initiator devices STA_A transmit an UL LMR frame, which may include timestamps for t₁ and t₄ captured by the initiator devices STA_A.

In some implementations, each of the initiator devices may compensate for clock offsets relative to the responder device AP by adjusting the captured timestamps for times t₁ and t₄ to generate corrected timestamps t₁′ and t₄′, for example, as described with respect to the example ranging operation 500 of FIGS. 5A-5B. The initiator devices STA_A may report the corrected timestamps t₁′ and t₄′ to the responder device AP in the UL LMR frames. In other implementations, the initiator devices STA_A may report estimated carrier frequency offset values and information indicative of the captured timestamps t₁ and t₄ to the responder device AP in the UL LMR frames.

In some implementations, the difference value (t_{diff_41}) indicative of t₄−t₁ may be adjusted based on a value of CFO_{TX} to generate a corrected difference value t_{diff_41}′ that compensates for clock offsets between the responder device AP and an initiator device. The corrected difference value t_{diff_41}′=t₄′−t₁′ may be reported to the responder device AP in a UL LMR frame. In some implementations, the value of CFO_{TX} also may be reported to the responder device AP in the UL LMR frame.

In addition, or in the alternative, the difference value (t_{diff_32}) indicative of t₃−t₂ may be adjusted based on the value of CFO_{TX} to generate a corrected difference value t_{diff_32}′ that compensates for clock offsets between the responder device AP and an initiator device. The corrected difference value t_{diff_32}′ may be reported to the initiator device in a DL LMR frame. In some implementations, the value of CFO_{TX} also may be reported to the initiator device in the DL LMR frame. In other implementations, the corrected timestamps t₂′ and t₃′ may be reported to the initiator device in the DL LMR frame (rather than the adjusted difference value t_{diff_32}′).

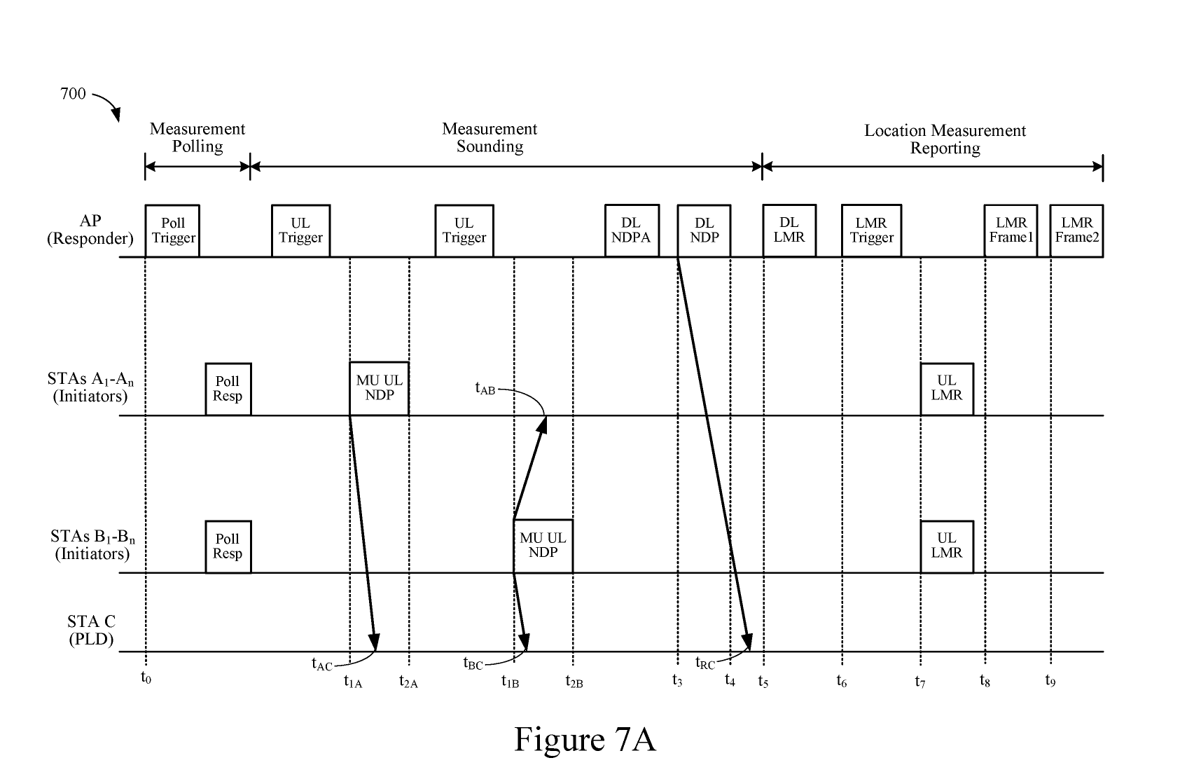

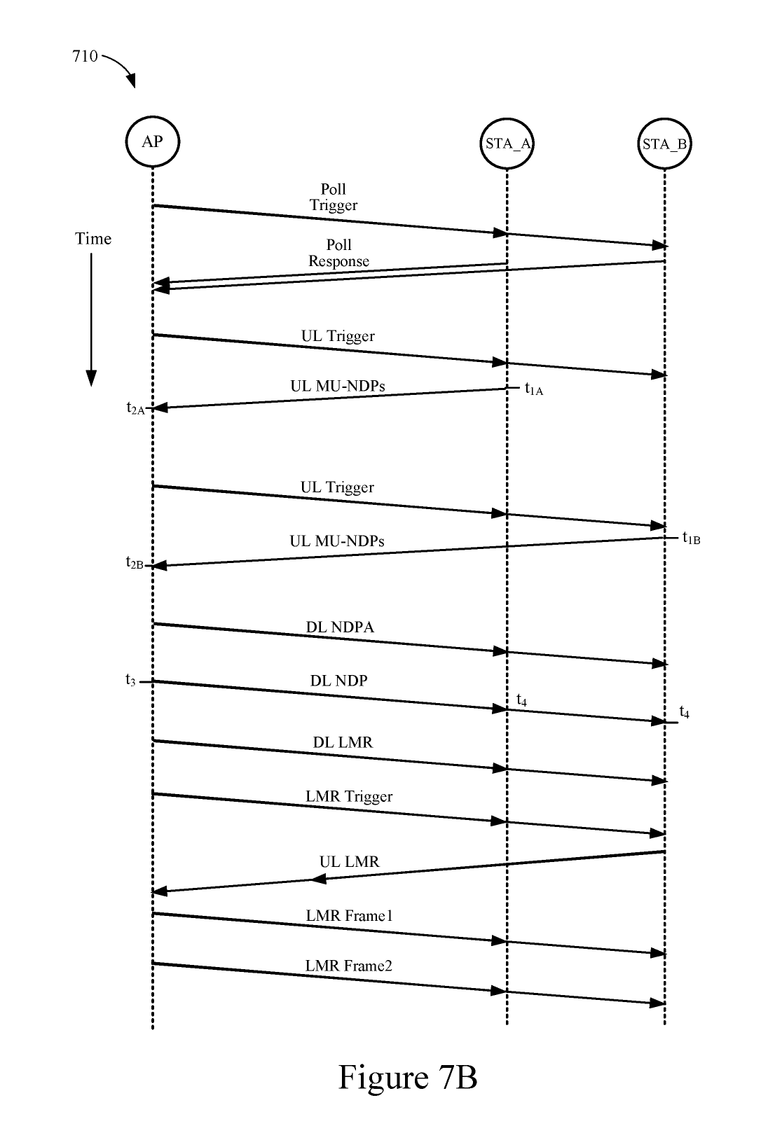

FIG. 7A shows a signal diagram of another example ranging operation 700, and FIG. 7B shows a sequence diagram of the example ranging operation 700 of FIG. 7A. The ranging operation 700 is performed between the responder device AP and the initiator devices STA_A and STA_B, and may be used by a third station STA_C to passively determine its location. The AP may be any suitable AP including, for example, the AP 110 of FIG. 1 or the AP 200 of FIG. 2. Each of the stations STA_A, STA_B, and STA_C may be any suitable station, for example, one of the STAs 120a-120i of FIG. 1 or the STA 300 of FIG. 3. Although two groups of stations STA_A and STA_B (as initiator devices) and one station STA_C (as a passive listening device) are shown in the example of FIG. 7A, in some other implementations, any number of initiator devices (or groups of initiator devices) may participate in the example ranging operation 700, and any number of passive listening devices may use measurement frames exchanges between the responder device AP and the initiator devices STA_A and STA_B to determine their locations.

The example ranging operation 700 of FIG. 7A is similar to the example ranging operation 500 of FIG. 5A, except for the presence of a passive listening device (PLD) that may passively determine its location by listening to measurement frames exchanged between the responder device AP and the initiator devices STA_A and STA_B. In some implementations, the passive listening device may capture a timestamp indicative of the TOA of the first MU UL NDP frames (transmitted by the first stations STA_A) at the passive listening device as time t_{AC}, may capture a timestamp indicative of the TOA of the second MU UL NDP frames (transmitted by the second stations STA_B) at the passive listening device as time t_{BC}, and may capture a timestamp indicative of the TOA of the DL NDP frame (transmitted by the responder device AP) at the passive listening device as time t_{RC}. Also, the passive listening device may receive timestamps for times t₂ and t₃ (or alternatively a difference value indicative of t₃−t₂) included in the DL LMR frame, may receive timestamps for times t₄ and t_{1A} (or alternatively a difference value indicative of t₄−t_{1A}) included in the first UL LMR frame transmitted by the first stations STA_A, and may receive timestamps for times t₄ and T_{1B} (or alternatively a difference value indicative of t₄−t_{1B}) included in the second UL LMR frame transmitted by the second stations STA_B. The passive listening device may use its captured timestamps and the received timestamps to passively determine its location.

In some implementations, the responder device AP may, beginning at time t₅, broadcast one or more additional LMR frames that include timestamps for t₁, t₂, t₃, and t₄. The additional LMR frames may be easier to receive by the passive listening device, as compared to the DL LMR frame and the UL LMR frames, because the additional LMR frames are broadcast frames.

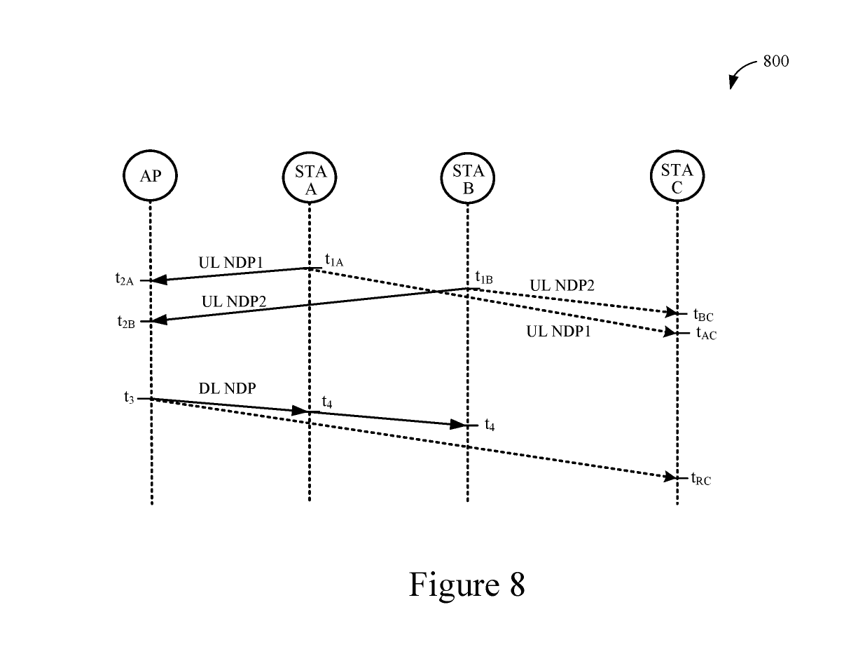

FIG. 8 shows a signal diagram of an example passive positioning operation 800. The example passive positioning operation 800 may be used by the passive listening device (station STA_C) of FIG. 7A to passively determine its location based on captured TOA values of received frames, timestamp values reported in the DL LMR frame, and timestamp values reported in the UL LMR frame. In some implementations, the passive listening device receives the first UL MU-NDPs from the first stations STA_A at time t_{AC} and receives the second UL MU NDPs from the second stations STA_B at time t_{BC}. The passive listening device receives the DL NDP transmitted from the responder device AP at time t_{RC}. The passive listening device may use the captured timestamps t_{AC}, t_{BC}, and t_{RC} corresponding to the reception of the first UL MU-NDPs, the second UL MU-NDPs, and the DL NDP, respectively, and the timestamps for times t₂ and t₃ provided by the DL LMR frame to calculate a number of differential distances between itself and the responder device AP and the initiator devices STA_A and STA_B. In some implementations, the passive listening device may calculate the differential distance (D1) between itself and each of the responder device AP and a first station STA_A using the expression:

D1=[t_{RC}−t_{AC}−(t₃−t₂+ToF₁)]*c,

where ToF₁ is the time-of-flight between the AP and STA_A, and c is the speed of light.

Similarly, the passive listening device may calculate the differential distance (D2) between itself and each of the responder device AP and a second station STA_B using the expression:

D2=[t_{AC}−t_{BC}−(t₃−t₂+ToF₂)]*c,

where ToF₂ is the time-of-flight between the AP and STA_B, and c is the speed of light.

The passive listening device may use well-known hyperbolic navigation techniques to determine its location based on calculated differential distances. Because the passive listening device does not transmit any frames (but rather listens to the NDPs exchanged between the responder device AP and the initiator devices STA_A and STA_B), the passive listening device may determine its location using less power (such as compared to active ranging operations).

The passive listening device may estimate a CFO value between itself and the responder device AP based on DL data transmitted from the responder device AP and may estimate a CFO value between itself and a given initiator device based on UL data transmitted from the given initiator device.

In some implementations, each of the initiator devices STA_A and STA_B of FIG. 7A may adjust its transmit carrier frequency based on an estimated CFO value between itself and the responder device AP and may report the estimated CFO value to the responder device AP. This may allow the responder device AP to adjust the t₁ and t₄ timestamps reported by the initiator device. If the initiator devices STA_A and STA_B adjust their captured timestamps based on estimated CFO values relative to the responder device AP to generate corrected timestamps, then the passive listening device may adjust all received timestamps based on an estimated CFO between itself and the responder device AP.

In some other implementations, an initiator device may select one of the timestamps t₁-t₄ as a reference timestamp (t_{REF}), and may adjust the other timestamps relative to the reference timestamp to generate a set of corrected timestamps. The corrected timestamps, which may compensate for clock offsets between the responder device AP and the initiator device, may be reported to the responder device AP in UL LMR frames. The responder device AP may use the corrected timestamps reported by the initiator device to obtain accurate RTT values without receiving estimated CFO values from the initiator device, thereby reducing the size and transmit duration of the UL LMR frames. In other implementations, the initiator device may report an estimated carrier frequency offset value and information indicative of its captured timestamps to the responder device AP in the UL LMR frames.

If the initiator devices STA_A and STA_B do not adjust their own timestamps based on their CFO values relative to the responder device AP, then the passive listening device may need to adjust the timestamps received from the initiator devices based on the estimated CFO value between itself and the initiator device, and may need to adjust the timestamps received from the responder device AP based on the estimated CFO value between itself and the responder device AP.

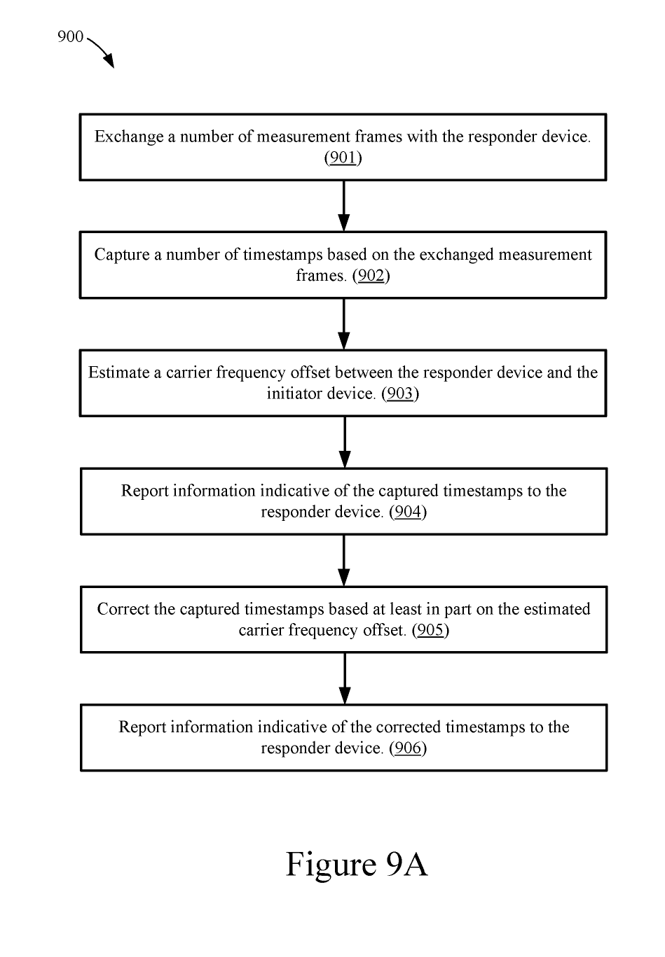

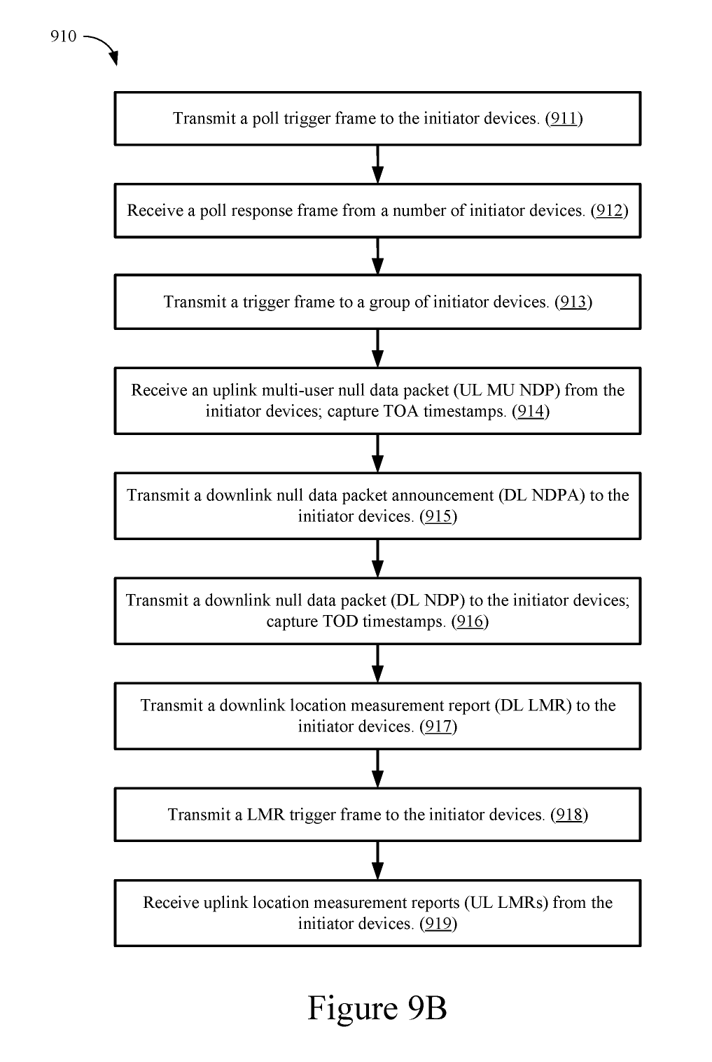

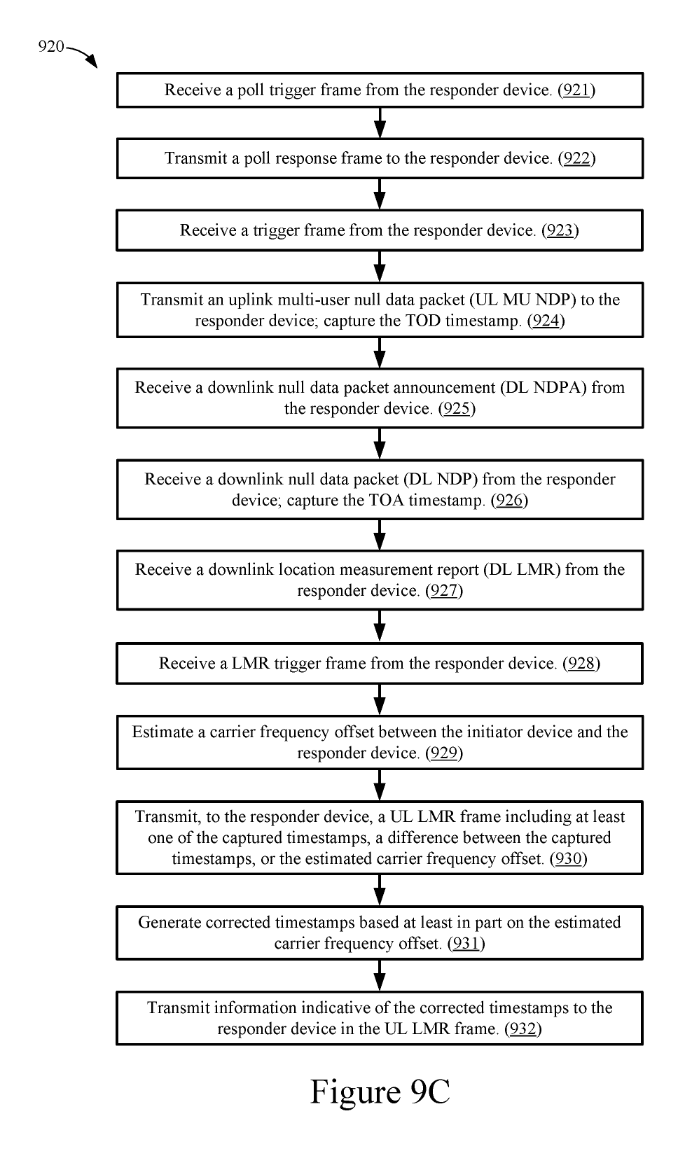

FIG. 9A shows an illustrative flow chart depicting an example ranging operation 900. In some implementations, the example ranging operation 900 may correspond to the example ranging operation 500 of FIGS. 5A and 5B. In some other implementations, the example ranging operation 900 may correspond to the example ranging operation 700 of FIGS. 7A and 7B.

The initiator device may exchange a number of measurement frames with the responder device (901), and may capture a number of timestamps based on the exchanged measurement frames (902). In some implementations, the exchanged measurement frames include at least one of: down-link multi-user null data packets (DL MU-NDPs) transmitted from the responder device; an up-link multi-user null data packet (UL MU-NDP) transmitted from the initiator device; and an up-link single-user null data packet (SU UL NDP).

The initiator device may estimate a carrier frequency offset between the responder device and the initiator device (903). In some implementations, the carrier frequency offset may be estimated based on at least one of the exchanged measurement frames. In some implementations, the initiator device adjusts a transmit carrier frequency on its transmitted Uplink Null Data Packet (UL NDP) based at least in part on the estimated carrier frequency offset. In some implementations, the responder device may not adjust its transmit carrier frequency on its transmitted Downlink Null Data Packet (DL NDP).

The initiator device may report information indicative of the captured timestamps to the responder device (904). In some implementations, the reported information may include at least one of the captured timestamps, a difference between the captured timestamps in the form of carrier frequency offset between the responder device and the initiator device, or an indication of the estimated carrier frequency offset. In some implementations, the initiator device may transmit the estimated carrier frequency offset to the responder device.

In some implementations, the initiator device may correct the captured timestamps based at least in part on the estimated carrier frequency offset (905). In some implementations, correcting the captured timestamps may include selecting one of the timestamps as a reference timestamp and adjusting the timestamps based on the reference timestamp and the estimated carrier frequency offset. In some implementations, the reference timestamp includes a time of departure (TOD) of an uplink multi-user null data packet (UL MU-NDP) or an uplink null data packet (UL NDP) transmitted from the initiator device. In some implementations, the reference timestamp is set to a zero value or is an arbitrary value based on a counter. In some implementations, the initiator device may determine a round-trip time (RTT) to the responder device based on the corrected timestamps.

The initiator device may report information indicative of the corrected timestamps to the responder device (906). In some implementations, the reported information may include at least one of the corrected timestamps or a difference between the corrected timestamps in the form of carrier frequency offset between the responder device and the initiator device. In some implementations, the initiator device may transmit the estimated carrier frequency offset to the responder device.

FIG. 9B shows an illustrative flow chart depicting an example ranging operation 910. In some implementations, the example ranging operation 910 may correspond to the example ranging operation 500 of FIGS. 5A and 5B. In some other implementations, the example ranging operation 910 may correspond to the example ranging operation 700 of FIGS. 7A and 7B.

The responder device may transmit a poll trigger frame to the initiator devices (911), and may receive a poll response frame from a number of initiator devices (912). The poll trigger frame may solicit measurement requests from nearby initiator devices, and the poll response frames may request the responder device to commence a measurement sounding for a corresponding one of the initiator devices.

The responder device may transmit an UL trigger frame to a group of initiator devices (913). The UL trigger frame solicits a number of the initiator devices to transmit an UL MU NDP to the responder device. In some implementations, the UL trigger frame may identify the initiator devices using their assigned AID values, RID values, or both.

The responder device may receive the UL MU NDPs from the initiator devices, and captures the TOA of the UL MU NDPs (914). The UL MU NDPs may include a number of sounding sequences from which multiple RTT values may be obtained (and from which channel conditions may be estimated).

The responder device may transmit a downlink null data packet announcement (DL NDPA) to the initiator devices (915). The DL NDPA informs the initiator devices to listen for an NDP to be transmitted from the responder device.

The responder device may transmit a downlink null data packet (DL NDP) to the initiator devices and captures the TOD of the DL NDP (916). The DL NDP may include a number of sounding sequences from which multiple RTT values may be obtained (and from which channel conditions may be estimated).

The responder device may transmit downlink location measurement report (DL LMR) to the initiator devices (917), and may transmit a LMR trigger frame to the initiator devices (918). The LMR trigger frame solicits the initiator devices to report measurement results (such as timestamps corresponding to the TOD of the UL MU NDP from each initiator device and the TOA of the DL NDP at each initiator device or a timestamp difference value).

The responder device may receive uplink location measurement reports (UL LMRs) transmitted from the initiator devices (919). In some implementations, the UL LMRs may include the captured timestamps, a difference between the captured timestamps, or an indication of the estimated carrier frequency offset. In some other implementations, the UL LMRs may include corrected timestamps t₁′ and t₄′ that compensate for clock offsets between the responder device and the initiator devices.

FIG. 9C shows an illustrative flow chart depicting an example ranging operation 920. In some implementations, the example ranging operation 920 may correspond to the example ranging operation 500 of FIGS. 5A and 5B. In some other implementations, the example ranging operation 920 may correspond to the example ranging operation 700 of FIGS. 7A and 7B.

Each initiator device may receive a poll trigger frame from the responder device (921), and may transmit a poll response frame to the responder device (922). The poll trigger frame may solicit measurement requests from the initiator devices, and the poll response frames may request the responder device to commence a measurement sounding for each of the responding initiator devices.

The initiator device may receive an UL trigger frame from the responder device (923). The UL trigger frame solicits a number of the initiator devices to transmit an UL MU NDP to the responder device, and may identify the initiator devices using their assigned AID values, RID values, or both.

The initiator device may transmit a UL MU NDP to the responder device, and may capture the TOD of the UL MU NDP (924). The UL MU NDP may include a number of sounding sequences from which multiple RTT values may be obtained (and from which channel conditions may be estimated).

The initiator device may receive a downlink null data packet announcement (DL NDPA) from the responder device (925). The DL NDPA informs the initiator devices to listen for an NDP to be transmitted from the responder device.

The initiator device may receive a downlink null data packet (DL NDP) from the responder device, and may capture the TOA of the DL NDP (926). The DL NDP may include a number of sounding sequences from which multiple RTT values may be obtained (and from which channel conditions may be estimated).

The initiator device may receive a downlink location measurement report (DL LMR) from the responder device (927). The DL LMR may include timestamps captured by the responder device.

The initiator device may receive a LMR trigger frame from the responder device (928). The LMR trigger frame solicits the initiator devices to report measurement results.

The initiator device may estimate a carrier frequency offset between itself and the responder device (929). In some implementations, the initiator device may use the reception of DL data frames from the responder device to estimate the carrier frequency offset between itself and the responder device.

The initiator device may transmit, to the responder device, an uplink location measurement report (UL LMR) frame including at least one of the captured timestamps, a difference between the captured timestamps, or the estimated carrier frequency offset (930). The responder device may use the received information, along with its captured timestamps, to estimate one or more RTT values.

The initiator device may generate corrected timestamps based at least in part on the estimated carrier frequency offset between itself and the responder device (931). In some implementations, the initiator device may generate the corrected timestamps by selecting one of the timestamps as a reference timestamp, and adjusting the timestamps based on the reference timestamp and the estimated carrier frequency offset. The initiator device may transmit information indicative of the corrected timestamps to the responder device in the UL LMR frame (932). In some implementations, the UL LMR frame may include corrected timestamps t₁′ and t₄′ that compensate for clock offsets between the responder device and the initiator devices. In some other implementations, the UL LMR frame may include a difference value indicative of a difference between the corrected timestamps t₁′ and t₄′ (such as t_{diff41}=t₄′−t₁′).

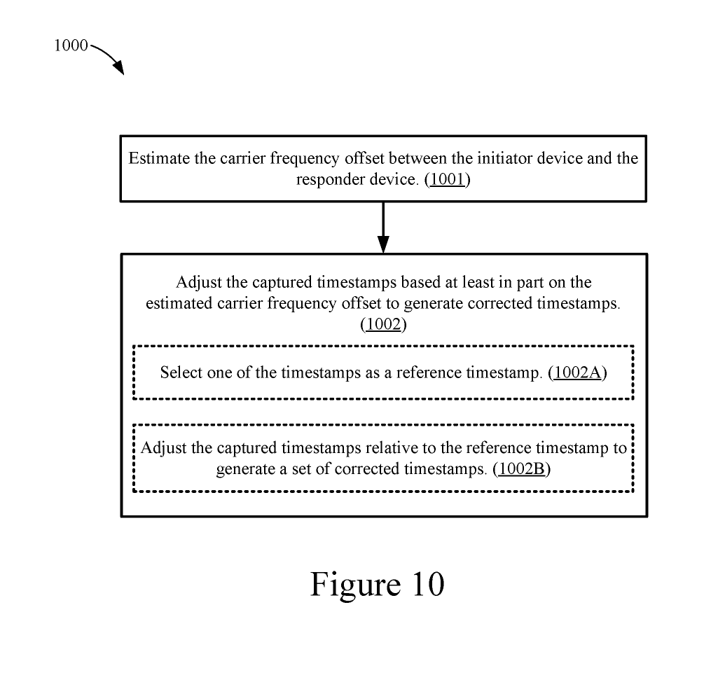

FIG. 10 shows an illustrative flowchart depicting an example operation 1000 for adjusting timestamps. In some implementations, the example operation 1000 may be performed by the initiator device in one or more of the example ranging operations 500, 600, and 700 of FIGS. 5A, 5B, 6A, 6B, 7A and 7B, respectively.

The initiator device may estimate the carrier frequency offset between itself and the responder device (1001), and may adjust the captured timestamps based at least in part on the estimated carrier frequency offset to generate corrected timestamps (1002). In some implementations, the initiator device may select one of the timestamps as a reference timestamp (1002A), and may adjust the captured timestamps relative to the reference timestamp to generate a set of corrected timestamps (1002B). The corrected timestamps may compensate for clock offsets between the responder device and the initiator device, and may be generated before the initiator device reports timestamps to the responder device.

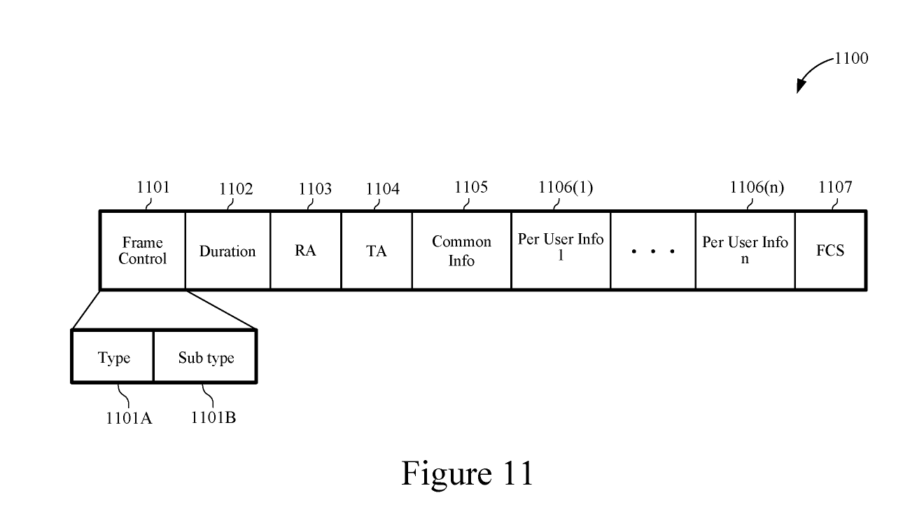

FIG. 11 shows an example trigger frame 1100. The trigger frame 1100 is shown to include a frame control field 1101, a duration field 1102, a receiver address (RA) field 1103, a transmitter address (TA) field 1104, a Common Info field 1105, a number of Per User Info fields 1106(1)-1106(n), and a frame check sequence (FCS) field 1107.

The frame control field 1101 includes a Type field 1101A and a Sub-type field 1101B. The Type field 1101A may store a value to indicate that frame 1100 is a control frame, and the Sub-type field 1101B may store a value indicating a trigger frame. The duration field 1102 may store information indicating a duration or length of the trigger frame 1100. The RA field 1103 may store the address of a receiving device (such as one of the initiator devices STA_A and STA_B of FIGS. 5A, 5B, 6A, 6B, 7A and 7B). The TA field 1304 may store the address of a transmitting device (such as the responder device AP of FIGS. 5A, 5B, 6A, 6B, 7A and 7B). The Common Info field 1135 may store information common to one or more receiving devices. Each of the Per User Info fields 1106(1)-1106(n) may store information for a particular receiving device. The FCS field 1107 may store a frame check sequence (such as for error detection).

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of performing a ranging operation with a responder device, the method performed by an initiator device and comprising:
exchanging a number of measurement frames with the responder device;
capturing a number of timestamps based on the exchanged measurement frames;
estimating a carrier frequency offset between the responder device and the initiator device; and
reporting information indicative of the captured timestamps to the responder device.

2. The method of claim 1, wherein the reported information comprises at least one of the captured timestamps, a difference between the captured timestamps, or an indication of the estimated carrier frequency offset.

3. The method of claim 1, further comprising:
correcting the captured timestamps based at least in part on the estimated carrier frequency offset.

4. The method of claim 3, wherein correcting the captured timestamps comprises:
selecting one of the timestamps as a reference timestamp; and
adjusting the timestamps based on the reference timestamp and the estimated carrier frequency offset.

5. The method of claim 4, further comprising:
reporting information indicative of the corrected timestamps to the responder device.

6. The method of claim 4, wherein the reference timestamp comprises a time of departure (TOD) of an uplink multi-user null data packet (UL MU-NDP) or an uplink null data packet (UL NDP) transmitted from the initiator device.

7. The method of claim 1, wherein the carrier frequency offset is estimated based on at least one of the exchanged measurement frames.

8. The method of claim 1, wherein the exchanged measurement frames include at least one of:
down-link multi-user null data packets (DL MU-NDPs) transmitted from the responder device;
an up-link multi-user null data packet (UL MU-NDP) transmitted from the initiator device; and
an up-link single-user null data packet (SU UL NDP).

9. The method of claim 1, further comprising:
adjusting a transmit carrier frequency of the initiator device based at least in part on the estimated carrier frequency offset.

10. The method of claim 1, wherein the responder device does not adjust its transmit carrier frequency.

11. The method of claim 1, further comprising:
transmitting the estimated carrier frequency offset to the responder device.

12. An apparatus for performing a ranging operation with a responder device, comprising:
one or more transceivers configured to exchange wireless signals with one or more wireless devices;
one or more processors; and
a memory comprising instructions that, when executed by the one or more processors, cause the apparatus to:
exchange a number of measurement frames with the responder device;
capture a number of timestamps based on the exchanged measurement frames;
estimate a carrier frequency offset between the responder device and the apparatus; and
report information indicative of the captured timestamps to the responder device.

13. The apparatus of claim 12, wherein the reported information comprises at least one of the captured timestamps, a difference between the captured timestamps, or an indication of the estimated carrier frequency offset.

14. The apparatus of claim 12, wherein execution of the instructions further causes the apparatus to:
correct the captured timestamps based at least in part on the estimated carrier frequency offset.

15. The apparatus of claim 14, wherein execution of the instructions further causes the apparatus to:
report information indicative of the corrected timestamps to the responder device.

16. The apparatus of claim 14, wherein execution of the instructions to correct the captured timestamps further causes the apparatus to:
select one of the timestamps as a reference timestamp; and
adjust the timestamps based on the reference timestamp and the estimated carrier frequency offset.

17. The apparatus of claim 16, wherein the reference timestamp comprises a time of departure (TOD) of an uplink multi-user null data packet (UL MU-NDP) or an uplink null data packet (UL NDP) transmitted from the apparatus.

18. The apparatus of claim 12, wherein the carrier frequency offset is estimated based on at least one of the exchanged measurement frames.

19. The apparatus of claim 12, wherein the exchanged measurement frames include at least one of:
down-link multi-user null data packets (DL MU-NDPs) transmitted from the responder device;
an up-link multi-user null data packet (UL MU-NDP) transmitted from the apparatus; and
an up-link single-user null data packet (SU UL NDP).

20. The apparatus of claim 12, wherein execution of the instructions further causes the apparatus to:
adjust a transmit carrier frequency of the apparatus based at least in part on the estimated carrier frequency offset.

21. The apparatus of claim 12, wherein the responder device does not adjust its transmit carrier frequency.

22. The apparatus of claim 12, wherein execution of the instructions further causes the apparatus to:
transmit the estimated carrier frequency offset to the responder device.

23. A non-transitory computer-readable medium storing instructions that, when executed by one or more processors of an apparatus, cause the apparatus to perform a ranging operation with a responder device by performing operations comprising:
exchanging a number of measurement frames with the responder device;
capturing a number of timestamps based on the exchanged measurement frames;
estimating a carrier frequency offset between the responder device and the apparatus; and
reporting information indicative of the captured timestamps to the responder device.

24. The non-transitory computer-readable medium of claim 23, wherein execution of the instructions causes the apparatus to perform operations further comprising:
correcting the captured timestamps based at least in part on the estimated carrier frequency offset.

25. The non-transitory computer-readable medium of claim 23, wherein the exchanged measurement frames include at least one of:
down-link multi-user null data packets (DL MU-NDPs) transmitted from the responder device;
an up-link multi-user null data packet (UL MU-NDP) transmitted from the apparatus; and
an up-link single-user null data packet (SU UL NDP).

26. The non-transitory computer-readable medium of claim 23, wherein execution of the instructions causes the apparatus to perform operations further comprising:
adjusting a transmit carrier frequency of the apparatus based at least in part on the estimated carrier frequency offset.

27. The non-transitory computer-readable medium of claim 23, wherein execution of the instructions causes the apparatus to perform operations further comprising:
transmitting the estimated carrier frequency offset to the responder device.

28. An apparatus, comprising:
means for exchanging a number of measurement frames with a responder device;
means for capturing a number of timestamps based on the exchanged measurement frames;
means for estimating a carrier frequency offset between the responder device and the apparatus; and
means for reporting information indicative of the captured timestamps to the responder device.

29. The apparatus of claim 28, further comprising:
means for correcting the captured timestamps based at least in part on the estimated carrier frequency offset.

30. The apparatus of claim 28, wherein the exchanged measurement frames include at least one of:
down-link multi-user null data packets (DL MU-NDPs) transmitted from the responder device;
an up-link multi-user null data packet (UL MU-NDP) transmitted from the apparatus; and
an up-link single-user null data packet (SU UL NDP).
